(19) United States
(12) Patent Application Publication
(10) Pub. No.: US 2022/0053139 A1
(43) Pub. Date: Feb. 17, 2022

(54) IMAGE PROCESSING DEVICE, IMAGE PROCESSING METHOD, AND PROGRAM

(71) Applicant: Sony Corporation, Tokyo (JP)

(72) Inventor: Hiroyoshi FUJII, Kanagawa (JP)

(73) Assignee: Sony Corporation, Tokyo (JP)

(21) Appl. No.: 17/275,377

(22) PCT Filed: Oct. 18, 2019
(86) PCT No.: PCT/JP2019/041056

§ 371 Date: Mar. 11, 2021

(30) Foreign Application Priority Data
Nov. 2, 2018 (JP) 2018-207557

(51) Int. Cl. H04N 5/232; G06K 9/00

(52) U.S. Cl. CPC H04N 5/23299; H04N 5/23219; G06K 9/00805; G06K 9/00362; G06K 9/00127; H04N 5/23296

(57) ABSTRACT

An image processing device includes circuitry configured to detect states of a plurality of subjects in a first image and to set parameters corresponding to the detected states of the plurality of subjects. The circuitry is further configured to determine, on a basis of a combination of the parameters set for the plurality of subjects, an output range to obtain a second image.

### TECHNICAL FIELD

The present disclosure relates to an image processing device, an image processing method, and a program, and more particularly, to an image processing device, an image processing method, and a program which enable realization of more natural camerawork.

### BACKGROUND ART

There is a method of controlling camerawork in accordance with a state of a subject in a video.

For example, PTL 1 discloses a monitoring device which calculates an action evaluation value of a person included in a video obtained by using a wide angle camera and determines a person corresponding to the greatest action evaluation value as a target of image shooting performed by a PTZ camera.

Furthermore, PTL 2 discloses a control system which controls to perform image shooting so that both of a wearer who wears a worn object imitating a character and the character are within a view angle in a theme park.

### CITATION LIST

### Patent Literature

PTL 1: JP 2013-90063A

PTL 2: JP 2014-42190A

### SUMMARY OF INVENTION

### Technical Problem

In related art, there has been a technology of controlling camerawork on the basis of a result of detecting an action of one person in a video. However, there has been no technology of performing an optimum camerawork control in a case where each of a plurality of persons performs different types of actions.

The present disclosure has been made to solve the problems described above and there is a need for enabling realization of more natural camerawork.

### Solution to Problem

An image processing device according to the present disclosure includes: a parameter setting unit that sets a parameter corresponding to a state of each of a plurality of subjects in a video for each subject of which at least a state is detected; and a shooting control unit that controls a shooting range of the video obtained by a shooting device, on the basis of the parameter set for each subject.

An image processing method according to the present disclosure includes: setting, by an image processing device, a parameter corresponding to a state of each of a plurality of subjects in a video for each subject of which at least a state is detected; and controlling, by the image processing device, a shooting range of the video obtained by a shooting device, on the basis of the parameter set for each subject.

A program according to the present disclosure causes a computer to execute processing that includes: setting a parameter corresponding to a state of each of a plurality of subjects in a video for each subject of which at least a state is detected; and controlling a shooting range of the video obtained by a shooting device, on the basis of the parameter set for each subject.

According to the present disclosure, a parameter corresponding to a state of each of a plurality of subjects in a video is set for each subject of which at least a state is detected, and a shooting range of the video obtained by a shooting device is controlled on the basis of the parameter set for each subject.

An image processing device according to an aspect of the present disclosure includes circuitry that detects states of a plurality of subjects in a first image, sets parameters corresponding to the detected states of the plurality of subjects, and determines, on a basis of a combination of the parameters set for the plurality of subjects, an output range to obtain a second image.

An image processing method according to an aspect of the present disclosure includes detecting states of a plurality of subjects in a first image, setting, by an image processing device, parameters corresponding to the detected states of the plurality of subjects, and determining, by the image processing device and on a basis of a combination of the parameters set for the plurality of subjects, an output range to obtain a second image.

A non-transitory computer-readable storage medium according to an aspect of the present disclosure includes computer-readable instructions therein, which, when executed by a computer, cause the computer to execute a method including detecting states of a plurality of subjects in a first image, setting parameters corresponding to the detected states of the plurality of subjects, and determining, on a basis of a combination of the parameters set for the plurality of subjects, an output range to obtain a second image.

### BRIEF DESCRIPTION OF DRAWINGS

FIG. 1 is a diagram showing an overview of a shooting system according to an embodiment of the present disclosure.

FIG. 2 is a block diagram showing an example of a configuration of the shooting system.

FIG. 3 is a block diagram showing an example of a functional configuration of an image processing device.

FIG. 4 is a flowchart for describing camerawork control processing.

FIG. 5 is a block diagram showing an example of a detailed functional configuration of an image processing device.

FIG. 6 is a flowchart for describing camerawork control processing.

FIG. 7 is a diagram showing an example of a two-dimensional coordinate system set in a video.

FIG. 8 is a diagram for describing a control of a shooting view angle at a time T1.

FIG. 9 is a diagram for describing a control of a shooting view angle at a time T2.

FIG. 10 is a diagram for describing a control of a shooting view angle at a time T3.

FIG. 11 is a diagram for describing a control of a shooting view angle at a time T4.

FIG. 12 is a diagram showing an example of a three-dimensional coordinate system set in a video.

FIG. 13 is a block diagram showing an example of a configuration of a computer.

FIG. 14 is a block diagram showing an example of a configuration of a biological sample observation system.

FIG. 15 is a block diagram showing an example of a functional configuration of an information processing device in FIG. 14.

FIG. 16 is a block diagram showing an example of a schematic configuration of a vehicle control system.

FIG. 17 is an explanatory diagram showing an example of installation positions of outside-vehicle information detecting units and image capturing units.

FIG. 18 is a block diagram showing an example of a functional configuration of an integrated control unit in FIG. 16.

FIG. 19 is a diagram showing an example of a schematic configuration of an endoscopic operation system.

FIG. 20 is a block diagram showing an example of functional configurations of a camera head and a CCU.

FIG. 21 is a block diagram showing an example of a functional configuration of the CCU in FIG. 20.

### DESCRIPTION OF EMBODIMENTS

Hereinafter, modes (hereinafter, referred to as embodiments) for implementing the present disclosure will be described. Note that descriptions will be provided in the following order.

1. Problems in Lecture Capture System According to Related Art

2. Configuration of Shooting System According to Embodiment of Present Disclosure

3. Configuration and Operation of Image processing Device

4. Configuration and Operation for Controlling Camerawork in Accordance with Actions of Plurality of Persons

5. Modified Example

6. Example of Configuration of Computer

7. Example of Application

### <1. Problems in Lecture Capture System According to Related Art>

In recent years, a lecture capture system that records a lecture in a school such as a college to realize attendance of the lecture in a remote place has been provided. In a case of shooting a student, camerawork is controlled by detecting an action of the student in the lecture capture system. A video in which camerawork is switched in accordance with an action of a student is recorded, for example, when one student stands up, the student is enlarged and shot.

At this time, a person observes the action of the student with naked eyes and the camerawork is switched manually by the person on the basis of a result of the observation. If the camerawork can be automatically switched in accordance with the observed action, it is possible to realize a reduction in the number of observers. In other words, a function of detecting an action of a student and controlling camerawork in accordance with a result of the action detection may be needed in order to reduce the number of observers.

Here, an example in which a standing student is enlarged and shot will be described as an example of a control of camerawork in accordance with a result of action detection.

First, shooting is performed at a view angle at which a bird's eye view of a classroom in which a plurality of students are seated is shot. The shooting of the bird's eye view is continued as long as standing-up of a student is not detected in a video.

In a case where one student stands up at a certain timing, standing-up is detected as a result of action detection in a video being obtained by shooting a bird's eye view. As a result, a view angle is controlled so that a standing student is reflected to fully fill the view angle.

Accordingly, the standing student can be enlarged and shot according to a control of camerawork in accordance with the result of the student action detection. Note that in this case, the standing student is enlarged and shot on the premise that the standing student is an important subject which should receive attention; however, shooting at a different view angle can also be performed depending on a detected action or contents of a lecture.

The control of the camerawork in accordance with the result of the action detection described above has the following problems.

### (Problem 1)

As in the example described above, the camerawork can be controlled on the basis of the result of the action detection of one student. However, there has been no technology of performing an optimum camerawork control in a case where each of a plurality of students performs different types of actions.

### (Problem 2)

In a case where a plurality of types of actions consecutively appear, there is a possibility that a student who should be preferentially put within a shooting view angle is changed depending on an appearance order of these actions. However, there has been no technology of controlling camerawork in accordance with an action appearance order.

For example, in a case where hand-raising and standing-up are simultaneously detected, a standing student should be preferentially put within the shooting view angle. Meanwhile, in a case where hand-raising is detected after standing-up, since it is likely that a student who raises his/her hand speaks, the student who raises his/her hand should be preferentially put within the shooting view angle.

Therefore, hereinafter, a configuration and an operation of a system for solving the problems described above will be described.

### <2. Configuration of Shooting System According to Embodiment of Present Disclosure>

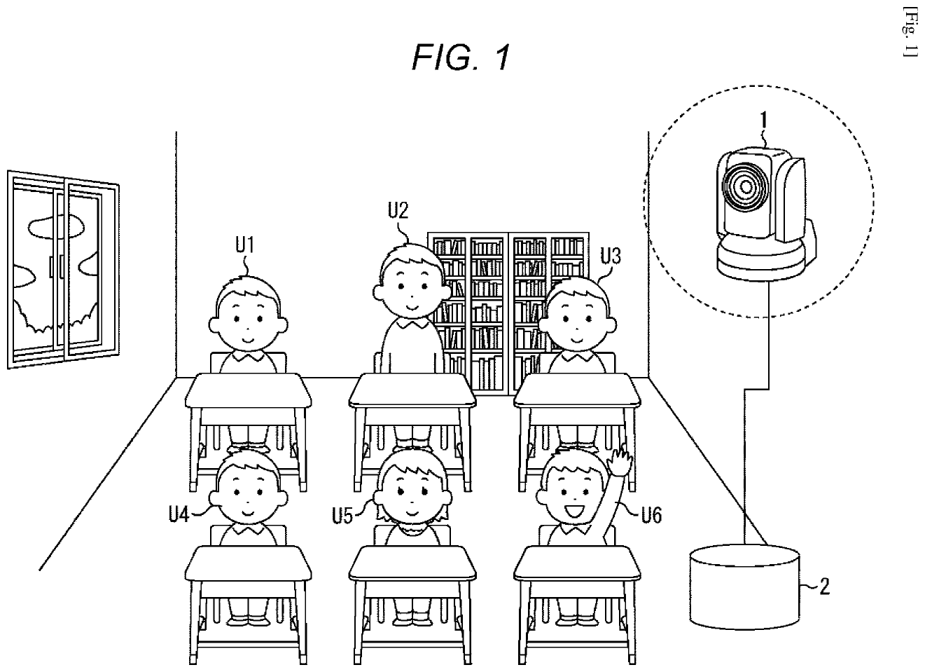

FIG. 1 is a diagram showing an overview of a shooting system according to an embodiment of the present disclosure.

A shooting system is implemented as a lecture capture system, and is installed in a classroom or a lecture hall in which a lecturer (not shown) delivers a lecture to a plurality of students U1 to U6.

FIG. 1 shows a situation in which six students U1 to U6 attend a lecture in a classroom.

A shooting device 1 is installed in a classroom to perform shooting at a shooting view angle at which all of the six students U1 to U6 are reflected. A video shot by the shooting device 1 is output to an image processing device 2.

The image processing device 2 detects an action of each of the students U1 to U6 on the basis of the video output from the shooting device 1 and controls the shooting device 1 on the basis of a detection result.

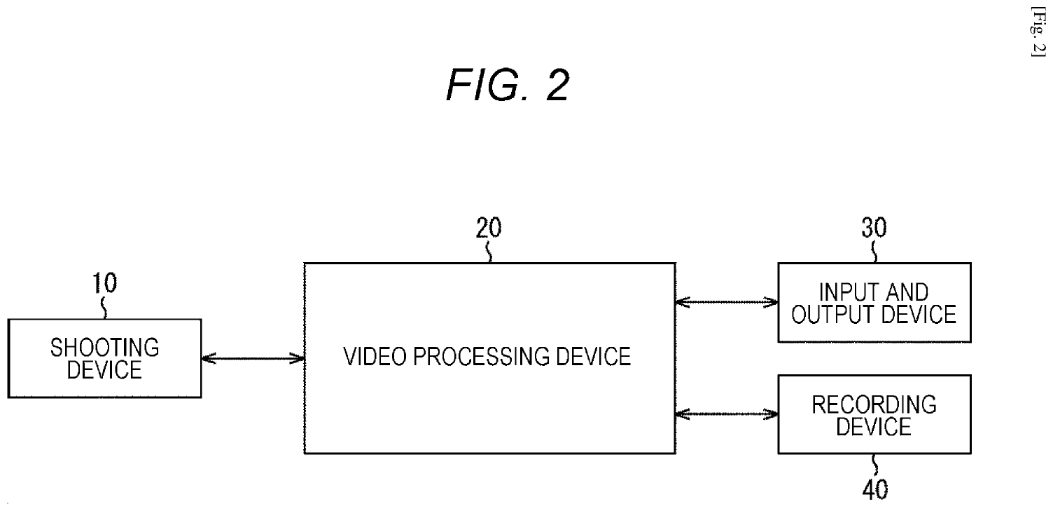

FIG. 2 is a block diagram showing an example of a configuration of the shooting system.

The shooting system in FIG. 2 includes a shooting device 10, an image processing device 20, an input and output device 30, and a recording device 40.

The shooting device 10 and the image processing device 20 correspond to the shooting device 1 and the image processing device 2 in FIG. 1, respectively.

The shooting device 10 has, for example, a mechanical panning and tilting function, and is implemented as an optically and electronically zoomable PTZ camera. The number of shooting devices 10 is not limited to one, and a plurality of shooting devices 10 may be provided. The shooting devices 10 are installed so that all of students are put within a shooting view angle of any one of one or more shooting devices 10 and the shooting view angle is controlled by the image processing device 20.

The image processing device 20 may be implemented by dedicated software having functions thereof, or may be implemented by a general computer and respective functions may be implemented by software. Furthermore, the shooting device 10 and the image processing device 20 may also be integrally implemented as one device, rather than being individually implemented.

The input and output device 30 is implemented by a keyboard or a mouse which receives an operation of a user, moreover, by a display or the like having a display function. A multichannel function may be provided in this display. The input and output device 30 receives an instruction based on an operation of the user and outputs the received instruction to the image processing device 20. Furthermore, the input and output device 30 presents various pieces of information supplied from the image processing device 20 to the user.

The input and output device 30 and the image processing device 20 may also be integrally implemented as one device, rather than being individually implemented. Furthermore, the input and output device 30 may be connected to the image processing device 20 through a network.

The recording device 40 records various pieces of information supplied from the image processing device 20. The information recorded in the recording device 40 is read by the image processing device 20 as necessary. A parameter corresponding to a state (here, an action of a person) of a subject is recorded in the recording device 40, and details will be described later.

The recording device 40 and the image processing device 20 may also be integrally implemented as one device, rather than being individually implemented. Furthermore, the recording device 40 may be connected to the image processing device 20 through a network.

<3. Configuration and Operation of Image processing Device>
(Example of Functional Configuration of Image processing Device)

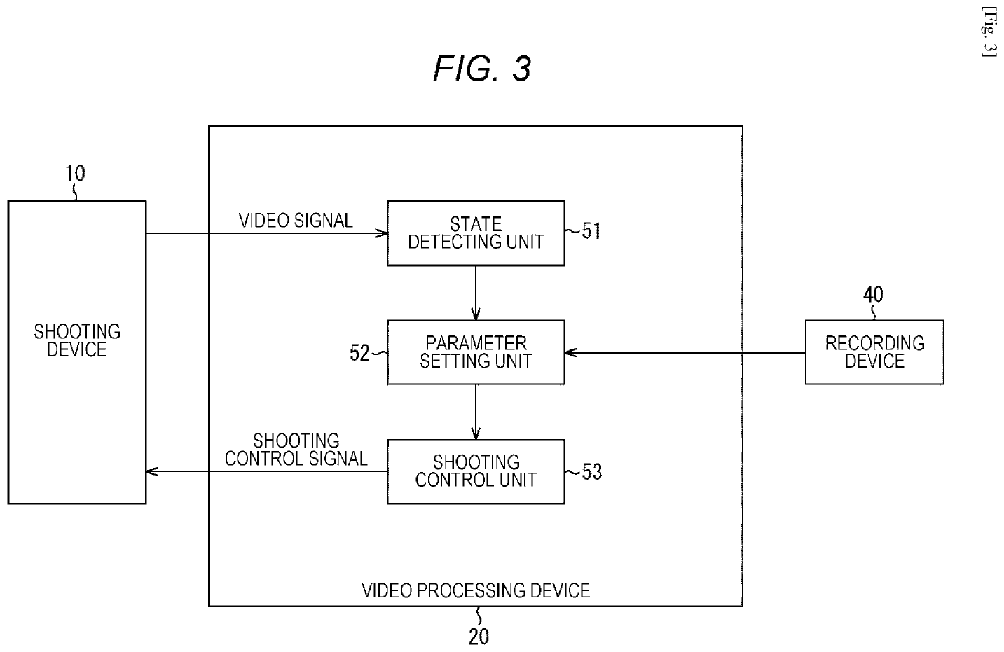

FIG. 3 is a block diagram showing an example of a functional configuration of the image processing device 20.

The image processing device 20 in FIG. 3 includes a state detecting unit 51, a parameter setting unit 52, and a shooting control unit 53.

The state detecting unit 51 detects a state of each of a plurality of subjects in a video represented by a video signal input from the shooting device 10 and supplies each detection result to the parameter setting unit 52.

The parameter setting unit 52 acquires a parameter corresponding to the state of each of the plurality of subjects in the video from the recording device 40 on the basis of the detection result supplied from the state detecting unit 51, and sets the parameter for each subject, of which at least a state is detected, among the plurality of subjects in the video. The parameter set for each subject is supplied to the shooting control unit 53.

The shooting control unit 53 controls the shooting (camerawork) performed by the shooting device 10 by using a shooting control signal. Specifically, the shooting control unit 53 controls a shooting view angle of the shooting device 10 and controls a cropping range of the video shot by the shooting device 10 on the basis of a combination of the parameters set for each of the subjects by the parameter setting unit 52, thereby controlling a shooting range of the video obtained by using the shooting device 10. The combination of the parameters includes all parameters set for every subject by the parameter setting unit 52, including parameters set to zero.

In the present disclosure, the shooting range controlled by the shooting control unit 53 corresponds to an output range of an output image, which is generated by control of the shooting view angle of the shooting device 10 and/or by cropping an image captured by the shooting device 10.

### (Camerawork Control Processing)

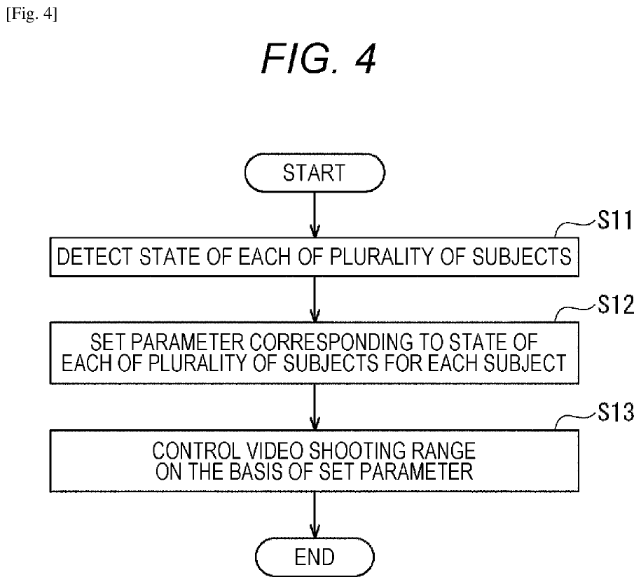

Next, camerawork control processing performed by the image processing device 20 will be described with reference to a flowchart of FIG. 4.

In step S11, the state detecting unit 51 detects a state of each of a plurality of subjects in a video shot by the shooting device 10. Examples of the state of the subject include an action of a person, or the like.

In step S12, the parameter setting unit 52 sets a parameter corresponding to the detected state of each of the plurality of subjects for each subject. The parameter is a weighting factor representing an attention level (importance) of each of the plurality of subjects in the video and has a value different for each of the states of the subjects.

In step S13, the shooting control unit 53 controls a shooting range of a video on the basis of the parameter (weighting factor) set for each subject. Specifically, the shooting control unit 53 determines a shooting range of a video by using a value of the weighting factor set for each subject.

According to the processing described above, the weighting factor representing an attention level (importance) is set, as a parameter corresponding to the state of each of the plurality of subjects in the video, for each subject, and thus it is possible to put an important subject which should receive attention in the video within the shooting range.

As a result, for example, in the lecture capture system, it is possible to realize more natural camerawork even in a case where a plurality of persons performs different types of actions, respectively.

Hereinabove, the basic configuration and operation according to the embodiment of the present disclosure have been described. Hereinafter, a specific configuration and operation for controlling camerawork in accordance with actions of a plurality of persons (students) in the shooting system (lecture capture system) in FIG. 1 will be described.

<4. Configuration and Operation for Controlling Camerawork in Accordance with Actions of Plurality of Persons>
(Example of Functional Configuration of Image processing Device)

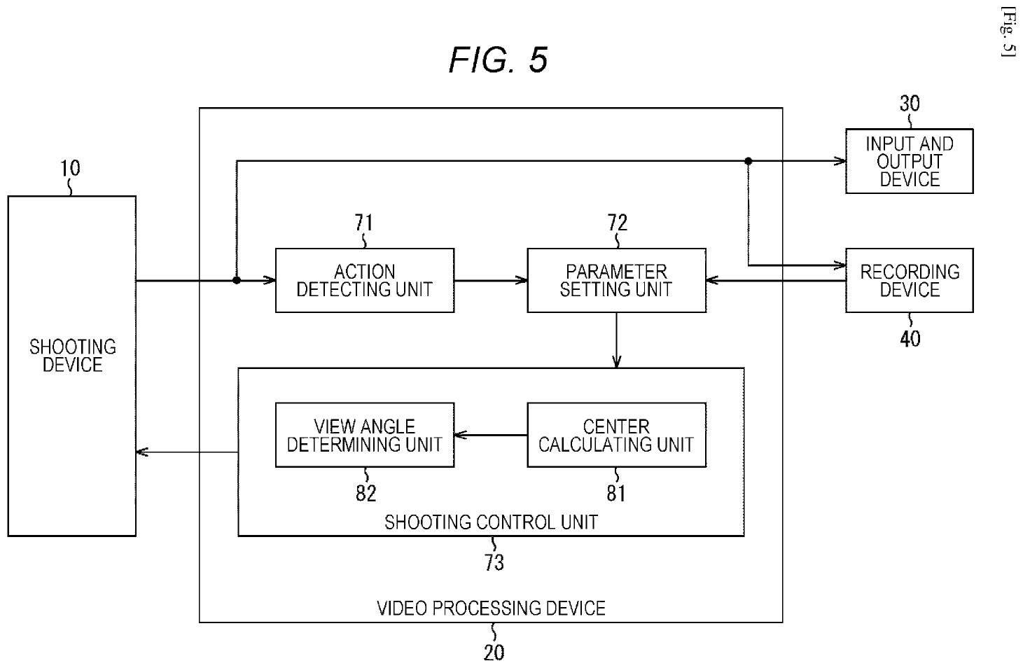

FIG. 5 is a block diagram showing an example of a functional configuration of an image processing device controlling camerawork in accordance with actions of a plurality of persons.

An image processing device 20 in FIG. 5 includes an action detecting unit 71, a parameter setting unit 72, and a shooting control unit 73.

The action detecting unit 71 detects at least one type of action of each of a plurality of persons (students) in a video shot by the shooting device 10. The action of a student to be detected is a motion which is performable by a student during a lecture. Examples of the motion which is performable during a lecture include standing-up, bow, hand-raising, seat-taking, moving-to-the-front, speaking (utterance), reading-out of a text book, note-taking in a notebook or the like, dozing-off, looking elsewhere, chatting (which is not talking about the contents of the lecture, but personal topics irrelevant to the lecture), and the like.

Action information indicating an action detection result is supplied to the parameter setting unit 72 together with specific information (for example, information indicating a position of a student in a video) specifying a student as a target of the action detection in the video.

The parameter setting unit 72 acquires a parameter corresponding to an action of each of the plurality of students in the video from the recording device 40 by using the action information and the specific information supplied from the action detecting unit 71, and sets the parameter for each student in the video.

Specifically, the parameter setting unit 72 sets a first weighting factor (hereinafter, also referred to as an action type weighting) defined for each type of action as a parameter for each student. Moreover, the parameter setting unit 72 sets a second weighting factor (hereinafter, also referred to as an action appearance order weighting) defined for each type of action as a parameter for each student. The action type weighting and the action appearance order weighting set for each student are supplied to the shooting control unit 73.

The shooting control unit 73 controls a shooting range (in embodiments, a shooting view angle) of the shooting device 10 on the basis of the action type weighting and the action appearance order weighting set for each student supplied from the parameter setting unit 72. That is, the shooting range is controlled on the basis of a combination of the weighting values set for every student, even when one or more of the set weighting values is zero.

The shooting control unit 73 includes a center calculating unit 81 and a view angle determining unit 82.

The center calculating unit 81 calculates a coordinate position (hereinafter, referred to as the center) in the video as the center of the shooting range (in embodiments, shooting view angle) of the shooting device 10 on the basis of the action type weighting and the action appearance order weighting set for each student. The view angle determining unit 82 determines the size of the shooting range (in embodiments, a shooting view angle) of the shooting device 10 on the basis of the center of the shooting range calculated by the center calculating unit 81 and a rule determined in advance. Information indicating the rule determined in advance is acquired from the recording device 40 through, for example, the parameter setting unit 72.

As noted above, the term “shooting range” is used to denote an output range of an output image, which is achieved by control of the shooting view angle of the shooting device 10 and/or by cropping an image captured by the shooting device 10. The output image which is obtained according to the control of the shooting range by the shooting control unit 73 is displayed on a display constituting the input and output device 30 or is recorded in the recording device 40.

### (Camerawork Control Processing)

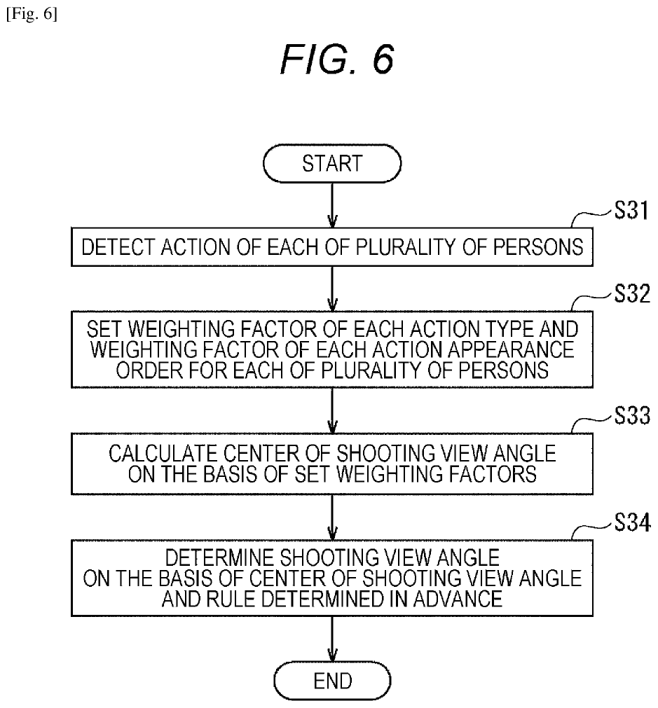

Next, camerawork control processing performed by the image processing device 20 in FIG. 5 will be described with reference to a flowchart of FIG. 6.

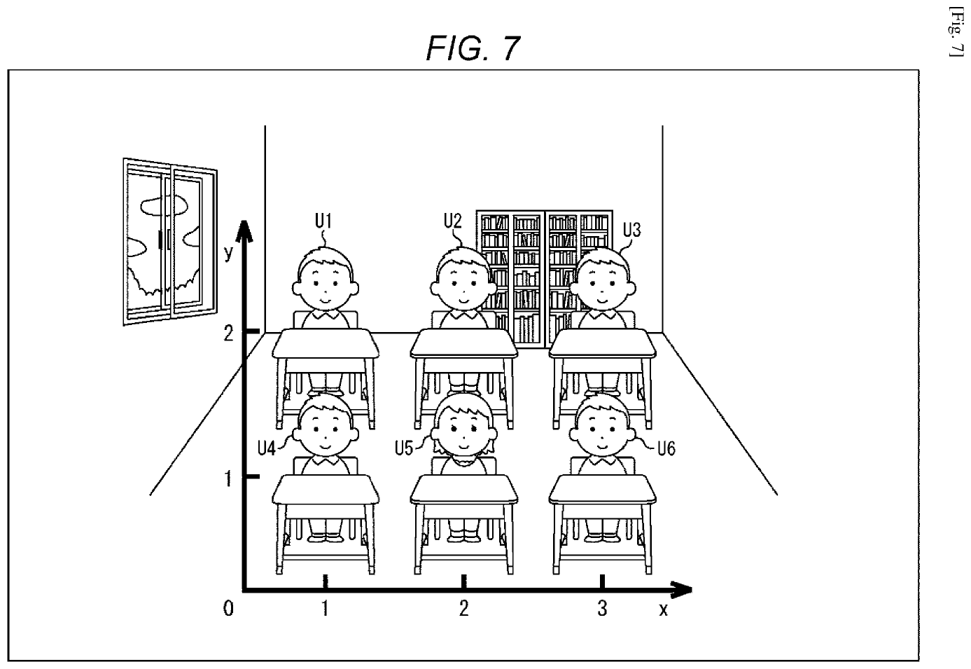

In this example, the camerawork control processing is executed for a video obtained by shooting a situation in which six students U1 to U6 attend a lecture in a classroom as shown in FIG. 7.

In the example in FIG. 7, a two-dimensional coordinate system defined by an x-axis and a y-axis is set in the video. For example, a student U1 is positioned at (x,y)=(1.0,2.0), and a student U6 is positioned at (3.0,1.0).

In the following, it is assumed that types of actions of a student to be detected are two types: standing-up and hand-raising.

When the video shown in FIG. 7 is supplied from the shooting device 10 to the image processing device 20, the action detecting unit 71 detects an action of each of the students U1 to U6 in the video supplied from the shooting device 10 in step S31.

In step 32, the parameter setting unit 72 sets a weighting factor of each action type and a weighting factor of each action appearance order of each of the students U1 to U6, in other words, an action type weighting and an action appearance order weighting for each student.

In this example, it is assumed that the action type weighting is 1.0 (standing-up), 0.5 (hand-raising), and 0.0 (none-detected), respectively, and the action appearance order weighting is 3.0 (hand-raising appearing after standing-up) and 1.0 (others), respectively.

In step S33, the center calculating unit 81 of the shooting control unit 73 calculates the center (the center of the shooting range) of the shooting view angle of the shooting device 10 on the basis of the set weighting factor.

Here, the center (gₓ,g_{y}) of the shooting view angle is represented by the following Equation (1), in which the action type weighting and the action appearance order weighting of each student position at coordinates (x,y) are w₁ and w₂, respectively.

$$( {g}_{x} , {g}_{y} ) = ( \frac{\sum {w}_{1} {w}_{2} x}{\sum {w}_{1} {w}_{2}} , \frac{\sum {w}_{1} {w}_{2} y}{\sum {w}_{1} {w}_{2}} ) . \qquad Equation 1$$

Once the center of the shooting view angle is calculated by using Equation (1) described above, in step S34, the view angle determining unit 82 of the shooting control unit 73 determines the shooting view angle (a size of the shooting range) of the shooting device 10 on the basis of the calculated center of the shooting view angle and the rule determined in advance.

Here, in a case where no action is detected according to the rule determined in advance, the same weighting factor (excluding 0) is set for all the students in the video and the center of the shooting view angle is calculated as exceptional processing, such that a view angle (bird's eye view angle) at which a bird's eye view of the entire classroom in which the students U1 to U6 attend the lecture is determined as the shooting view angle. Furthermore, in a case where a certain action (standing-up or hand-raising) is detected, a view angle within which, the whole body of a student of which the product of the action type weighting w₁ and the action appearance order weighting w₂ is the largest, is put is determined as the shooting view angle.

The pieces of processing in steps S31 to S34 described above are performed for each predetermined unit time such as, for example, each frame, of the video shot by the shooting device 10.

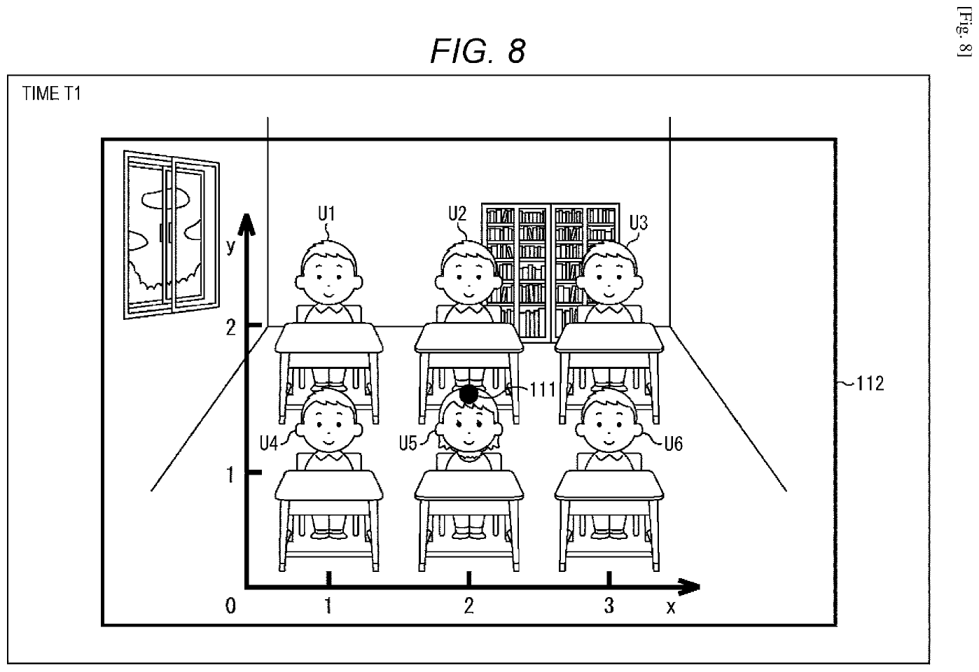

Here, controls of a shooting view angle at times T1 to T4 will be described with reference to FIGS. 8 to 11.

First, at a time T1 (FIG. 8), all the students U1 to U6 are seated in their own seats, and no action is detected. In this case, the center of the shooting view angle is indicated by a dot 111, and a coordinate position of the dot 111 is the center (gₓ,g_{y})=(2.0,1.5) of the coordinates of the respective students U1 to U6. Furthermore, the shooting view angle is a bird's eye view angle, and is indicated by a frame 112 in which all the students U1 to U6 are put, with the dot 111 as the center.

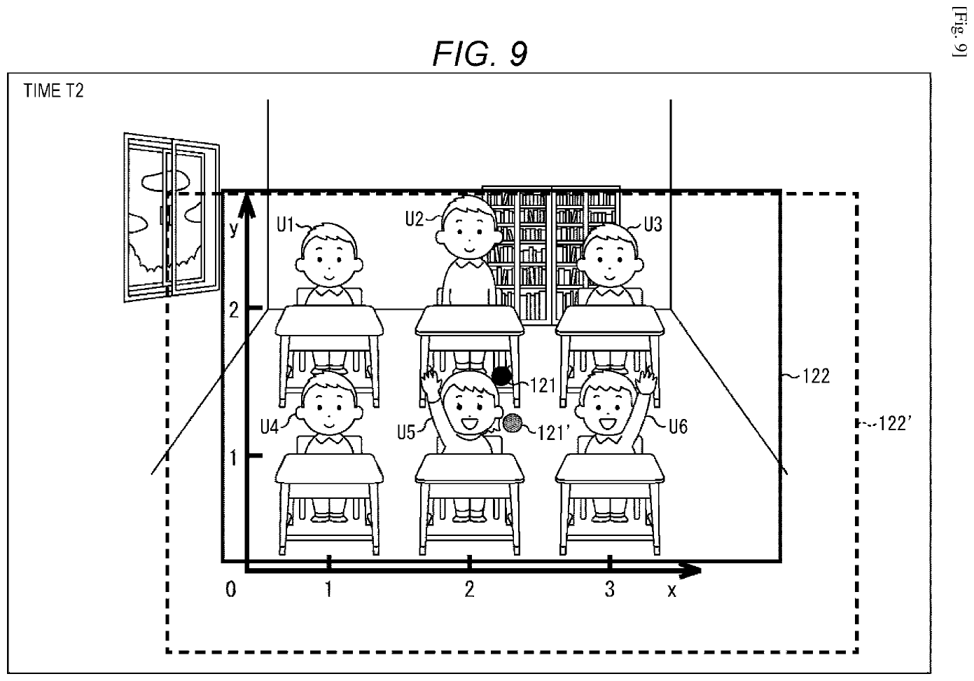

At a time T2 (FIG. 9), a student U2 stands up and students U5 and U6 raise their hands. In other words, w₁=1.0, w₂=1.0 for the student U2, and w₁=0.5, w₂=1.0 for each of the students U5 and U6. Note that, w₁=0.0, w₂=1.0 for students U1, U3, and U4. In this case, the center of the shooting view angle is indicated by a dot 121, and a coordinate position of the dot 121 is (gₓ,g_{y})=(2.25,1.5) as represented by the following Equation (2). Furthermore, the shooting view angle is indicated by a frame 122 in which the whole body of the student U2 of which the product of w₁ and w₂ is the largest is put, with the dot 121 as the center.

$$( {g}_{x} , {g}_{y} ) = ( \frac{1.0 \times 1.0 \times 2.0 + 0.5 \times 1.0 \times 2.0 + 0.5 \times 1.0 \times 3.0}{1.0 \times 1.0 + 0.5 \times 1.0 + 0.5 \times 1.0} , \frac{1.0 \times 1.0 \times 2.0 + 0.5 \times 1.0 \times 1.0 + 0.5 \times 1.0 \times 1.0}{1.0 \times 1.0 + 0.5 \times 1.0 + 0.5 \times 1.0} ) - ( 2.25 , 1.5 ) \qquad Equation 2$$

Here, for example, in a case where the weighting factor (w₁) of each action type is not defined and w₁=1.0 for both of standing-up and hand-raising, the center of the shooting view angle is indicated by a dot 121′ and a coordinate position of the dot 121′ is (gₓ,g_{y})=(2.3,1.3). Furthermore, the shooting view angle is indicated by a frame 122′ in which all the students U1 to U6 are put, with the dot 121′ as the center. Here, the shooting view angle is controlled so as to have the same aspect ratio even if any subject is put within the shooting view angle. In other words, the frame 122 and the frame 122′ have the same aspect ratio.

Comparing the frame 122 and the frame 122′ shown in FIG. 9 with each other, the weighting factor (w₁) for each action type is defined, such that the shooting view angle is set on the premise that the standing student U2 is an important subject which should receive attention.

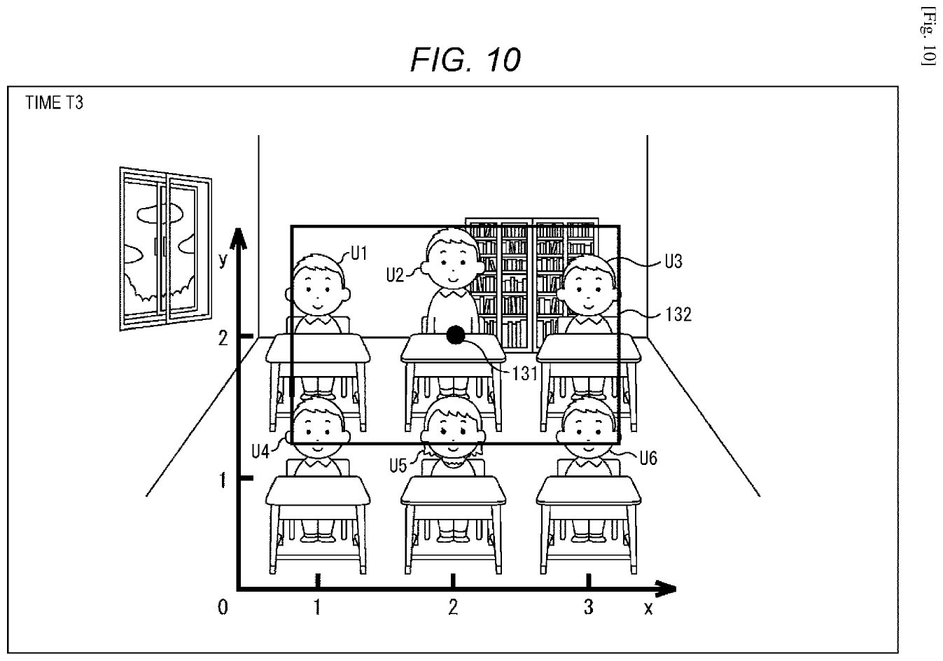

Next, at a time T3 (FIG. 10), the student U2 continues to stand and the students U5 and U6 stop raising their hands. In other words, w₁=1.0,w₂=1.0 only for the student U2, and w₁=0.0, w₂=1.0 for the students U1, U3, U4, and U6. In this case, the center of the shooting view angle is indicated by a dot 131, and a coordinate position of the dot 131 is a position (gₓ,g_{y})=(2.0,2.0) of the student U2. Furthermore, the shooting view angle is indicated by a frame 132 in which the whole body of the student U2 is put, with the dot 131 as the center. In other words, the shooting of the student U2 as a subject is continued.

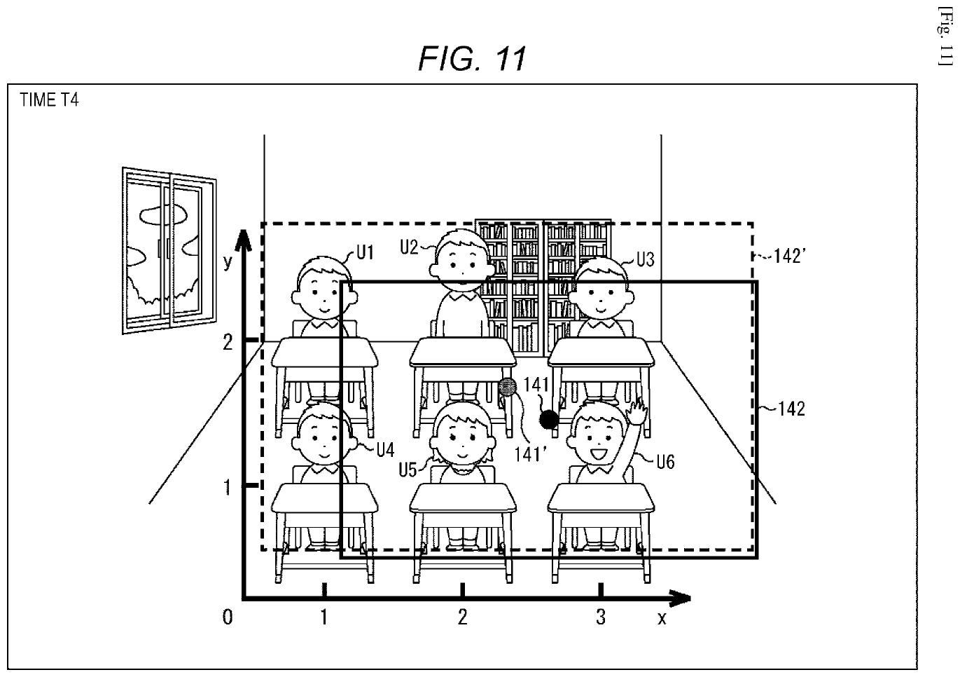

Further, at a time T4 (FIG. 11), the student U2 continues to stand up and the student U6 raises his/her hand again. In other words, w₁=1.0, w₂=1.0 for the student U2, and w₁=0.5,w₂=3.0 for the student U6. Note that w₁=0.0, w₂=1.0 for the students U1, U3, U4 and U5. In this case, the center of the shooting view angle is indicated by a dot 141, and a coordinate position of the dot 141 is (gₓ,g_{y})=(2.6,1.4) represented by Equation (1) described above. Furthermore, the shooting view angle is indicated by a frame 142 in which the whole body of the student U6 of which the product of w₁ and w₂ is the largest is put, with the dot 141 as the center.

Here, for example, in a case where the weighting factor (w₂) of each action appearance order is not defined and w₂=1.0 in any case, the center of the shooting view angle is indicated by a dot 141′ and a coordinate position of the dot 141′ is (gₓ,g_{y})=(2.3,1.7). Furthermore, the shooting view angle is indicated by a frame 142′ in which all the students U1 to U6 are put, with the dot 141′ as the center. Here, also, the frame 142 and the frame 142′ have the same aspect ratio.

Comparing the frame 142 and the frame 142′ shown in FIG. 11 with each other, the weighting factor (w₂) of each action appearance order is defined, such that the shooting view angle is set on the premise that the student U6 who raises his/her hand while another student stands up and is likely to speak next is an important subject which should receive attention.

According to the processing described above, weighting factors corresponding to an action type and an action appearance order of each of a plurality of students in a video are set for each student, and thus it is possible to put an important subject which should receive attention in the video within the shooting view angle. With this arrangement, it is possible to realize more natural camerawork even in a case where each of a plurality of students performs different types of actions.

Hereinabove, the example of the camerawork control under the assumption that the types of actions to be detected are two types including standing-up and hand-raising has been described. The present disclosure is not limited thereto, and it is also possible to realize desired camerawork by appropriately changing the type of action to be detected, the action type weighting, the action appearance order weighting, the equation for calculating the center, and the rule for determining the shooting view angle.

For example, it is not preferable that a student who performs an action irrelevant to a lecture such as dozing-off, looking elsewhere, chatting, or the like is put within the shooting view angle. In this regard, action type weighting of these actions each have a negative value, such that it is possible to realize camerawork in which a student who performs these actions is not put within the shooting view angle.

Furthermore, not only the shooting view angle is set so that an important subject which should receive attention is put within the shooting view angle, but also the rule for determining the shooting view angle is changed, such that it is also possible to set the shooting view angle so that all students of which actions are detected are put within the shooting view angle.

Moreover, a method for setting the weighting factor is not limited to the method described above, and it is also possible to appropriately change a value of the weighting factor as necessary. Furthermore, in a case where a specific action of a student is not detected, it is also possible to set a weighting factor having a value which is too small to affect calculation of the center of the shooting view angle when another action is detected. For example, in a case where a specific action of a student is not detected, an action type weighting is set to 0.00001. With this arrangement, it is possible to calculate the center of the shooting view angle without performing the exceptional processing even in a case where actions of all students are not detected, and it is possible to appropriately control the shooting view angle without affecting the calculation of the center of the shooting view angle even in a case where a certain action of a student is detected.

### <5. Modified Example>

Hereinafter, a modified example of the embodiment described above will be described.

### (As for Action Detection)

For student action detection, not only a video shot by the shooting device 10 but also distance information acquired by a distance sensor and sound information acquired by a microphone may be used.

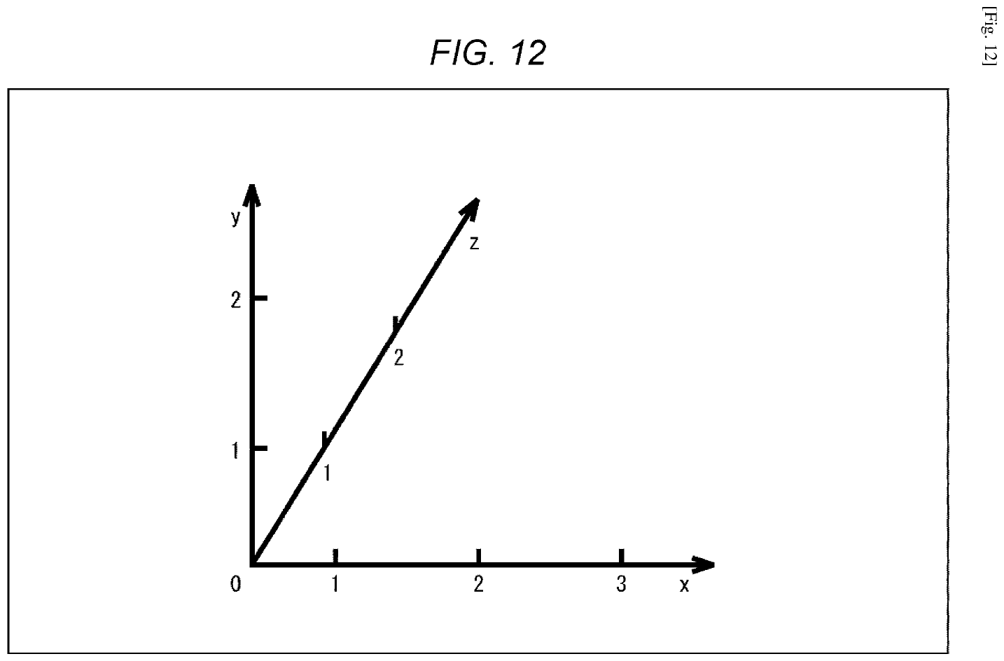

For example, in a case where the distance information acquired by the distance sensor is used, a three-dimensional coordinate system defined by an x-axis, a y-axis, and a z-axis may be set in the video as shown in FIG. 12. In this case, it is also possible to control the zoom of the shooting device 10 on the basis of distance information (a position in a z-axis direction) of a student as an important subject which should receive attention.

### (As for Weighting Factor)

A weighting factor as a parameter corresponding to an action has a value determined in advance for each action type or an action appearance order. However, the value may also be adjusted in response to a request of a user.

Furthermore, the same value is set as the weighting factor described above regardless of a student. However, weighting may be further applied for each student in accordance with information (context) associated with an individual student such as a frequency of standing-up or hand-raising of a student, contribution to a lecture, grades, or the like.

### (As for Determination of View Angle)

The shooting view angle may not only be determined for each predetermined unit time such as one frame or the like, but also be determined so that, for example, shooting view angles between frames are smoothly connected. In this case, for example, the shooting view angle is determined so that a movement of the center of the shooting view angle calculated in each frame and a change in a size of the shooting view angle between frames are further decreased.

With this arrangement, it is possible to decrease a visual load on a viewer caused by switching of the shooting view angles of the shot video.

### (Control of Shooting Range)

In a control of the shooting range, an electronically cropped range in a video shot by the shooting device 10 implemented by a wide-angle camera may be controlled additionally or alternatively to mechanically controlling the shooting view angle of the shooting device 10 configured as a PTZ camera. A video in the cropping range is enlarged to a predetermined size, such that a video which appears as if the cropping range is zoomed-in is output. Note that the cutting-off of the video may be performed by the image processing device 20 or may be performed by the shooting device 10.

Furthermore, in a case where, for example, two shooting devices 10 are provided, one of them may be a PTZ camera, and the other one may be a wide-angle camera. In this case, a shooting range of the PTZ camera can be controlled in accordance with an action of a person detected in a video shot by the wide-angle camera.

### <6. Example of Configuration of Computer>

The series of processing described above can be executed by hardware or can be executed by software. In a case where the series of processing is executed by software, a program constituting the software in a program recording medium is installed in a computer incorporated in dedicated hardware, a general-purpose personal computer, or the like.

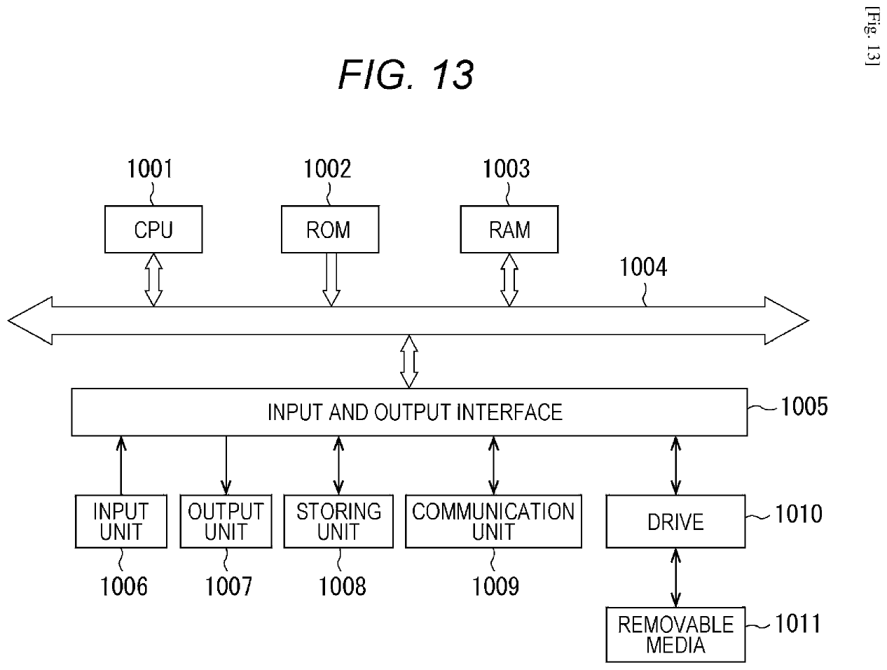

FIG. 13 is a block diagram showing an example of a configuration of hardware of a computer executing the series of processing described above by using a program.

The image processing device 20 described above is implemented by a computer having the configuration shown in FIG. 13.

A CPU 1001, a ROM 1002, and a RAM 1003 are connected to one another by a bus 1004.

Moreover, an input and output interface 1005 is connected to the bus 1004. An input unit 1006 implemented by a keyboard, a mouse, or the like, and an output unit 1007 implemented by a display, a speaker, or the like are connected to the input and output interface 1005. Furthermore, a storing unit 1008 implemented by a hard disk, a non-volatile memory, or the like, a communication unit 1009 implemented by a network interface or the like, and a drive 1010 driving removable media 1011 are connected to the input and output interface 1005.

In the computer configured as described above, the CPU 1001 loads, for example, a program stored in the storing unit 1008 to the RAM 1003 through the input and output interface 1005 and the bus 1004, and executes the program, such that the series of processing described above is performed.

The program executed by the CPU 1001 is recorded in, for example, the removable media 1011, or is provided through a wired or wireless transmission medium such as a local area network, Internet, and digital broadcasting, and installed in the storing unit 1008.

Note that the program executed by the computer may be a program by which the pieces of processing are performed in time series in the order described in the present specification, or may be a program by which the pieces of processing are performed in parallel or at a necessary timing such as when a call is performed or the like.

### <7. Example of Application>

Hereinabove, the example in which a target of action detection is a person has been described. However, in a case where the technology according to the present disclosure is applied to a system other than the lecture capture system, a target of action detection may also be an animal such as a dog, a cat, or the like.

Furthermore, in a system to which the technology according to the present disclosure is applied, in addition to an action of a person or an animal such as a dog, a cat, or the like in a video, a state of an object in the video may also be detected as a state of a subject in the video.

Specifically, in an education system such as a lecture capture system, states of a blackboard, a whiteboard, a monitor in a classroom, or experiment equipment such as a beaker, a flask, and the like as a plurality of objects reflected together with a plurality of persons (students or the like) in a video are detected. In this case, a parameter (weighting factor) corresponding to a detected state of an object is set for each object.

For example, as a state of a blackboard, an amount or density of contents written on the blackboard and a presence or absence of a bulletin such as a map or the like are detected. In this case, when the amount or density of the contents written on the blackboard is large, or when a bulletin is posted, a weighting factor with a large value is set. With this arrangement, the contents written on the blackboard and the bulletin are reflected in a video, thereby allowing a viewer to easily understand contents of a lecture.

Furthermore, as a state of a monitor, contents displayed on the monitor are detected. In this case, for example, when slides for a presentation are displayed on a monitor, a weighting factor with a large value is set. With this arrangement, the slides are reflected in a video, thereby making a viewer easily understand contents of the presentation.

Moreover, as a state of a beaker or a flask, an amount of chemicals as contents or an order in which the chemicals are handled is detected. In this case, a weighting factor is set according to the amount of chemicals or the order in which the chemicals are handled. With this arrangement, the state of the beaker or the flask is reflected in a video, thereby allowing a viewer to easily understand contents of an experiment.

Furthermore, in a broadcasting system for sports broadcasting, states of an advertisement around a ground, a score board, and a net for a ball game such as soccer, basketball, or the like as a plurality of objects reflected in a video together with a plurality of persons (players or the like) are detected. Also in this case, a parameter (weighting factor) corresponding to a detected state of an object is set for each object.

For example, as a state of an advertisement, a company as an advertiser is detected. In this case, when the company pays more advertisement fees, a weighting factor with a larger value is set. With this arrangement, the advertisement of the company is reflected in a video, such that it is possible to improve advertising impacts of the company.

Furthermore, as a state of a score board, a score display state is detected. In this case, when a display of a score is changed, a weighting factor with a larger value is set. With this arrangement, the score board when the score is changed is reflected in a video, thereby allowing a viewer to easily understand a situation of a game.

Moreover, as a state of the net, a presence or absence of a ball in the net or in the vicinity of the net is detected. In this case, when the ball is in the net or in the vicinity of the net, a weighting factor with a larger value is set. With this arrangement, a scene of goal is reflected in a video, such that it is possible to improve satisfaction of a viewer.

Note that in the example described above, a weighting factor corresponding to an action of a person in a video may be set in addition to a weighting factor corresponding to a detected state of an object, or only a weighting factor corresponding to a detected state of an object may be set.

Furthermore, in the shooting system to which the technology according to the present disclosure is applied, the shooting control unit 53 may also control shooting conditions such as a frame rate, resolution, and the like of a video to be shot, in addition to controlling a shooting range of a video by controlling a shooting view angle of the shooting device 10. These shooting conditions may each be controlled individually, or may be controlled in combination with one another. The control of the shooting conditions can be performed on the basis of a sum of parameters set for respective subjects detected in the video or a maximum value thereof.

For example, it is highly likely that a scene in which the sum of weighting factors in the video, or a maximum value of set weighting factors is larger than a predetermined value is an important scene. Therefore, in this case, a high resolution video is recorded by setting a high frame rate, a high resolution or a low compression rate of a video to be shot. Meanwhile, it is unlikely that a scene in which the sum of weighting factors in the video, or a maximum value of set weighting factors is larger than a predetermined value is an important scene. Therefore, in this case, a low frame rate, low resolution, or a high compression rate of a video to be shot is set, such that a video with low resolution is recorded.

Here, in setting of a frame rate or resolution, a frame rate or resolution may not only be set in stages by comparison with a predetermined value, but also be set so that the frame rate or resolution is continuously changed depending on, for example, a sum or a maximum value of weighting factors in a specific value range.

Hereinafter, an example of application in which the technology according to the present disclosure is applied to a system in a field other than the lecture capture system will be described.

### (Example of Application to a System for Observing Biological Sample)

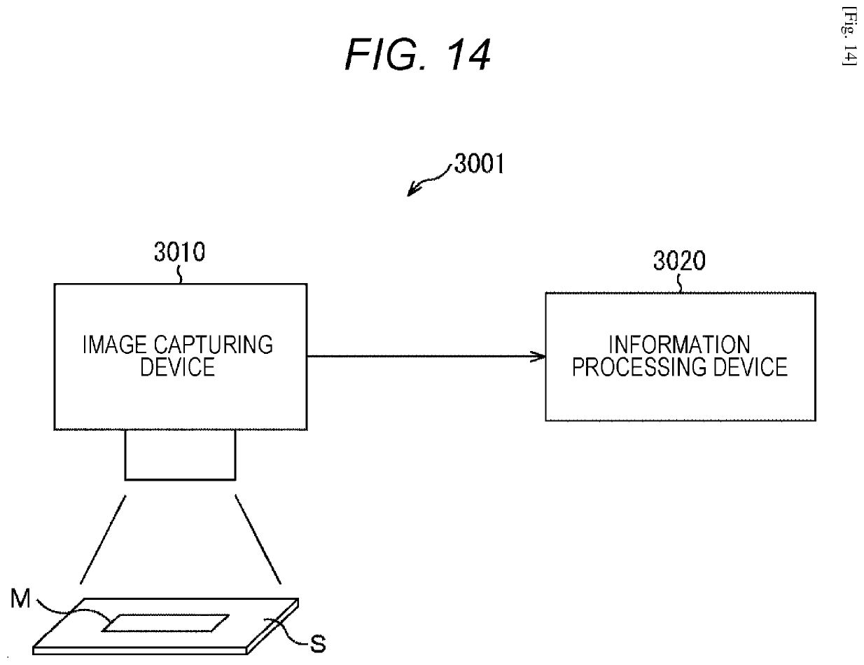

FIG. 14 is a block diagram showing an example of a configuration of a biological sample observation system to which the technology according to the present disclosure is applied.

As shown in FIG. 14, an observation system 3001 includes an image capturing device 3010 and an information processing device 3020. The image capturing device 3010 and the information processing device 3020 may be connected through various wired or wireless networks such as Internet or the like. With this arrangement, a user in a remote place can access the information processing device 3020 through a network, and can execute a desired control or operation.

The image capturing device 3010 is a device which generates a captured image (moving image). The image capturing device 3010 is implemented by, for example, a digital camera. The image capturing device 3010 may also be implemented by various devices having an image capturing function such as, for example, a smartphone, a tablet PC, a game machine, a wearable device, or the like.

The image capturing device 3010 includes various members such as an image capturing element such as a charge coupled device (CCD), a complementary metal oxide semiconductor (CMOS), or the like, a lens for controlling image formation of a subject image in the image capturing element, and the like, and performs image capturing by using the members. Here, not only a generally used visible light camera, but also a non-visible light (infrared or ultraviolet) camera, a polarization camera, or the like may be used as the image capturing device 3010 used for the image capturing, or a combination thereof may be used.

A method for shooting using the image capturing device 3010 can include bright-field observation in which a subject is observed with transmitted or reflected light, and dark-field observation in which a subject is observed with scattered light by diagonally applying light to the subject by using a special capacitor. Furthermore, the method for shooting using the image capturing device 3010 can also include phase different observation in which contrast is applied to a transparent subject by using diffraction and interference of light, and differential interference observation in which contrast is applied to an undyed subject with an optical path difference due to a refractive index at the time of light transmission or a shape of a surface of the subject. Moreover, the method for shooting using the image capturing device 3010 can also include fluorescence observation in which fluorescence from a subject is observed by applying light with a certain wavelength, polarization observation in which observation is performed by changing a polarization characteristic of a subject in accordance with contrast or color, or the like. However, the method for shooting using the image capturing device 3010 is not particularly limited thereto.

Furthermore, the image capturing device 3010 includes a communication device for transmitting and receiving a moving image or the like to and from the information processing device 3020. The image capturing device 3010 is provided above an image capturing stage S for capturing an image of a medium M in which a cell or the like as an observation target is cultured. The cell is an example of the biological sample. The image capturing device 3010 generates a moving image by capturing images of the medium M at a predetermined frame rate.

Note that the image capturing device 3010 may directly (without going through another member) capture the images of the medium M or may capture the images of the medium M through another member such as a microscope or the like. Furthermore, the frame rate described above is not particularly limited, but it is preferable that the frame rate is set in accordance with a degree of a change of an observation target. Note that the image capturing device 3010 captures an image of a specific image capturing region including the medium M in order to correctly track the change of the observation target. The moving image generated by the image capturing device 3010 is transmitted to the information processing device 3020.

It is assumed that the image capturing device 3010 is a camera installed in an optical microscope. However, the image capturing device 3010 may also be an image capturing device included in an electron microscope or the like using a beam of electrons such as a scanning electron microscope (SEM), a transmission electron microscope (TEM), or the like. Furthermore, the image capturing device 3010 may also be an image capturing device included in a scanning probe microscope (SPM) or the like using a short probe such as an atomic force microscope (AFM), a scanning tunneling microscope (STM), or the like.

An observation target of the observation system 3001 is mainly a biological sample. The biological sample is a living body which can be observed by using an optical microscope or the like, such as, for example, various cells, cell organelles, biological tissues, a microorganism, or an organism such as plankton or the like. Here, in particular, it is assumed that the biological sample is a living body which can move in the medium M on the image capturing stage S of the image capturing device 3010.

The information processing device 3020 is a device having an image analysis function. The information processing device 3020 is implemented by various devices having the image analysis function, such as a personal computer (PC), a table PC, a smartphone, or the like.

The information processing device 3020 analyzes a behavior of the observation target in the moving image acquired from the image capturing device 3010.

For example, the information processing device 3020 analyzes various behaviors (changes in shapes) of each cell in a situation in which a number of cells are present. In the analysis of the cell behavior, a region of interest in which a behavior of a cell is analyzed is specified in a moving image acquired from the image capturing device 3010, and a parameter based on a motion in the specified region of interest is set, thereby analyzing the behavior of the cell.

In the observation system 3001 described above, it is necessary to cut a region of interest in which a behavior of an observation target has been analyzed by using a human hand in order to use a result obtained by performing observation target behavior analysis as a material for a research paper or a lecture later, which takes a great deal of effort.

In this regard, the technology according to the present disclosure is applied to the observation system 3001 to thereby put a region of interest in a moving image within a shooting range of the moving image.

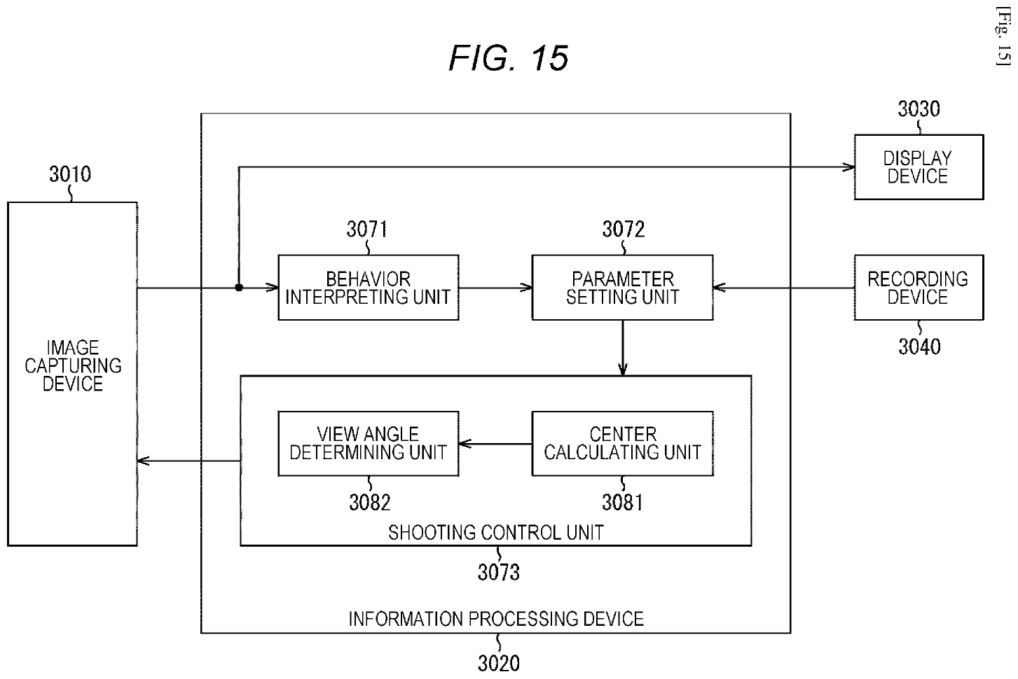

FIG. 15 is a block diagram showing an example of a functional configuration of the information processing device 3020 to which the technology according to the present disclosure is applied.

The information processing device 3020 in FIG. 15 includes a behavior analyzing unit 3071, a parameter setting unit 3072, and a shooting control unit 3073.

The behavior analyzing unit 3071 analyzes a behavior of each of observation targets (for example, a number of cells) in a moving image (observation video) captured by the image capturing device 3010.

The parameter setting unit 3072 acquires a parameter (weighting factor) corresponding to a behavior of an observation target from a recording device 3040 by using a result of the behavior analysis performed by the behavior analyzing unit 3071 and sets the parameter for each observation target in the moving image.

The shooting control unit 3073 controls a shooting range of the image capturing device 3010 on the basis of the weighting factor corresponding to the behavior of the observation target set by the parameter setting unit 3072, thereby cutting a region of interest. Note that a center calculating unit 3081 and a view angle determining unit 3082 included in the shooting control unit 3073 have functions similar to those of the center calculating unit 81 and the view angle determining unit 82 in FIG. 5, respectively, and thus a description thereof will be omitted.

The region of interest which is cut as the shooting range is controlled by the shooting control unit 3073 is displayed on a display device 3030.

For example, in the information processing device 3020, a weighting factor corresponding to an analyzed behavior of a cell is set, and a view angle control (crop) is performed on the basis of a result of the setting. Here, a behavior of a cell includes at least one of, for example, a beat, division, fusion, bonding, deformation, or movement.

The cropped image may be recorded in a separate recording device 3040. Furthermore, the cropped image may be displayed in a region which is different from a region in which the observation target is displayed.

The weighting factor corresponding to the behavior may be set in accordance with a purpose of a user. For example, in a case where a purpose of a user is to observe cell division, a weighting factor with a large value is set when division is confirmed by the behavior analysis, and a weighting factor with a small value is set when deformation is confirmed. With this arrangement, it is possible to more accurately observe cell division.

Furthermore, a weighting factor corresponding to a behavior appearance order of a cell may be set, and cropping may be performed on the basis of a result of the setting.

The weighting factor corresponding to the behavior appearance order may be set in accordance with, for example, a behavior in each stage of division of a biological sample.

For example, it is known that cell division of a fertilized egg is progressed in an order of 1-cell period, 2-cell period, 4-cell period, and 8-cell period.

Here, it is known that a characteristic motion caused by the cell division is observed in the division from the 1-cell period to the 2-cell period, and it is known that an unique motion caused by gene expression derived from an egg in the 2-cell period. Therefore, it is possible to determine that an activity of an embryo is high if these motions are observed.

Furthermore, it is known that a gradual change, in which the motion is gradually increased from the later part of the 4-cell period to the early part of the 8-cell period, and is decreased after the 8-cell period, is observed. It is said that the change is caused by gene expression derived from a sperm cell. Therefore, it is possible to determine that the gene expression derived from the sperm cell occurs in the embryo and the embryo is smoothly progressing to the next stage if such a change is observed.

As described above, in the observation of the cell division of the fertilized egg, it is important to detect each motion in each stage. It is likely that the cell division is being smoothly progressed in a case where, for example, the motion described above is captured in the 2-cell period and the motion is gradually increased from the later part of the 4-cell period and the early part of the 8-cell period as a result of the behavior analysis, and thus a weighting factor with a large value is set.

According to the configuration described above, a weighting factor corresponding to a behavior of each of a plurality of cells in an observation video is set for each cell, and thus it is possible to put an important cell which should receive attention in the observation video within a shooting range.

### (Example of Application to Moving Body Control System)

The technology according to the present disclosure may be implemented as a device mounted in any one of moving bodies such as a vehicle, an electric vehicle, a hybrid electric vehicle, a motorcycle, a bicycle, a personal mobility device, a plane, a drone, a ship, a robot, a construction machine, an agricultural machine (tractor), and the like.

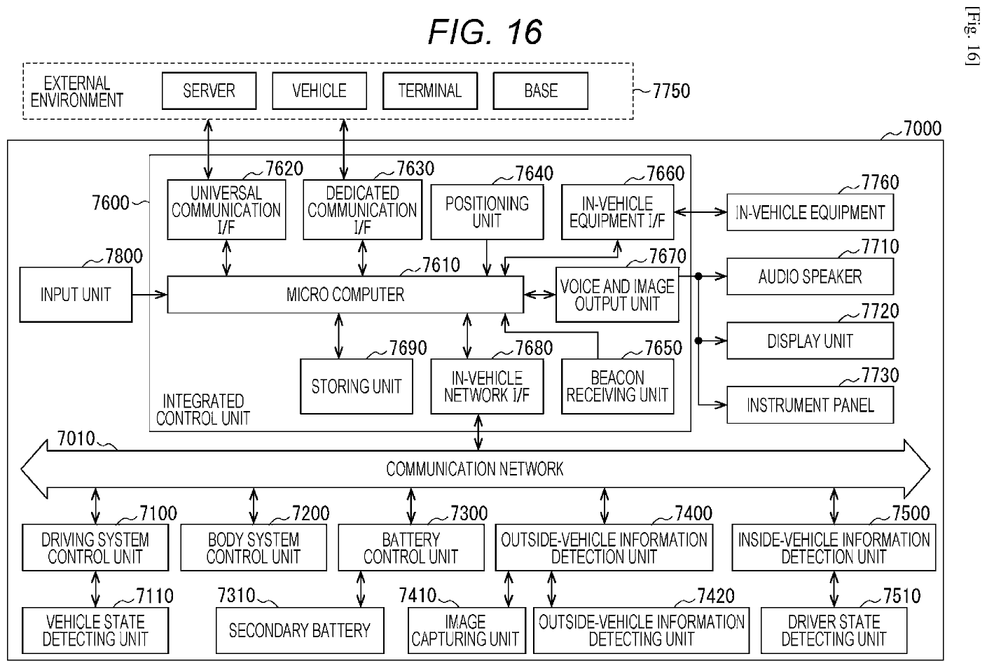

FIG. 16 is a block diagram showing an example of a schematic configuration of a vehicle control system 7000 which is an example of the moving body control system to which the technology according to the present disclosure can be applied. The vehicle control system 7000 includes a plurality of electronic control units connected through a communication network 7010. In the example shown in FIG. 16, the vehicle control system 7000 includes a driving system control unit 7100, a body system control unit 7200, a battery control unit 7300, an outside-vehicle information detection unit 7400, an inside-vehicle information detection unit 7500, and an integrated control unit 7600. The communication network 7010 connecting the plurality of control units to one another may be, for example, an in-vehicle communication network according to any protocol such as a controller area network (CAN), a local interconnect network (LIN), a local area network (LAN), a FlexRay (registered trademark), or the like.

Each control unit includes a microcomputer performing calculation processing according to various programs, a storing unit that stores programs executed by the microcomputer, parameters used for various calculations, or the like, and a driving circuit that drives various control target devices. Each control unit includes a communication I/F for performing communication with devices inside and outside a vehicle, a sensor, or the like through a wired or wireless communication, in addition to a network I/F for performing communication with another control unit through the communication network 7010. In FIG. 16, as a functional configuration of the integrated control unit 7600, a microcomputer 7610, a universal communication I/F 7620, a dedicated communication I/F 7630, a positioning unit 7640, a beacon receiving unit 7650, an in-vehicle equipment I/F 7660, an audio image output unit 7670, an in-vehicle network I/F 7680, and a storing unit 7690 are shown. Similarly, each of other control units also includes a microcomputer, a communication I/F, a storing unit, or the like.

The driving system control unit 7100 controls an operation of a device related to a driving system of a vehicle according to various programs. For example, the driving system control unit 7100 functions as a driving force generation device for generating a driving force of a vehicle such as an internal combustion engine, a driving motor, or the like, a driving force transferring mechanism for transferring a driving force to vehicle wheels, a steering mechanism for adjusting a steering angle of the vehicle, and a control device such as a brake device generating a braking force of the vehicle, or the like. The driving system control unit 7100 may have a function as a control device such as an antilock brake system (ABS), an electronic stability control (ESC), or the like.

A vehicle state detecting unit 7110 is connected to the driving system control unit 7100. The vehicle state detecting unit 7110 includes, at least one of, for example, a gyro sensor that detects an angular velocity of an axial rotation motion of a vehicle body, an acceleration sensor that detects an acceleration of a vehicle, or sensors for detecting an acceleration pedal operation amount, a brake pedal operation amount, a steering angle of a steering wheel, engine revolutions per minute, a rotation speed of a vehicle wheel, or the like. The driving system control unit 7100 performs calculation processing by using a signal input from the vehicle state detecting unit 7110 to control an internal combustion engine, a driving motor, an electric power steering device, or a brake device.

The body system control unit 7200 controls an operation of various devices mounted in a vehicle body according to various programs. For example, the body system control unit 7200 functions as a keyless entry system, a smart key system, a power window device, or a control device for various lamps such as a head lamp, a back lamp, a brake lamp, a blinker, a fog lamp, and the like. In this case, electric waves sent from a portable machine substituting for a key and a signal of various switches can be input to the body system control unit 7200. The body system control unit 7200 receives the electric waves or the signal to control a door-lock device of a vehicle, a power window device, a lamp, or the like.

The battery control unit 7300 controls a secondary battery 7310 as a power supply source of a driving motor according to various programs. For example, information such as a battery temperature, a battery output voltage, a state of charge of a battery, or the like is input to the battery control unit 7300 from a battery device including the secondary battery 7310. The battery control unit 7300 performs calculation processing by using the signal and performs a temperature adjustment control for the secondary battery 7310 or a control of a cooling device or the like included in the battery device.

The outside-vehicle information detection unit 7400 detects information regarding an outside area of a vehicle in which the vehicle control system 7000 is mounted. For example, at least one of an image capturing unit 7410 or the outside-vehicle information detecting unit 7420 is connected to the outside-vehicle information detection unit 7400. The image capturing unit 7410 includes at least one of a time of flight (ToF) camera, a stereo camera, a single-lens camera, an infrared camera, or other cameras. The outside-vehicle information detecting unit 7420 includes at least one of, for example, an environment sensor for detecting a current weather or meteorological condition, or a surrounding information detection sensor for detecting another vehicle around the vehicle in which the vehicle control system 7000 is mounted, an obstacle, a pedestrian, or the like.

The environment sensor may be at least one of, for example, a raindrop sensor detecting rain, a fog sensor detecting fog, a sunshine sensor detecting an amount of sunshine, or a snow sensor detecting snowfall. The surrounding information detection sensor may be at least one of an ultrasonic sensor, a radar device, or a light detection and ranging or laser imaging detection and ranging (LIDAR) device. The image capturing unit 7410 and the outside-vehicle information detecting unit 7420 may be included as individual sensors or devices, respectively, or may be included as a device in which a plurality of sensors or devices are integrated.

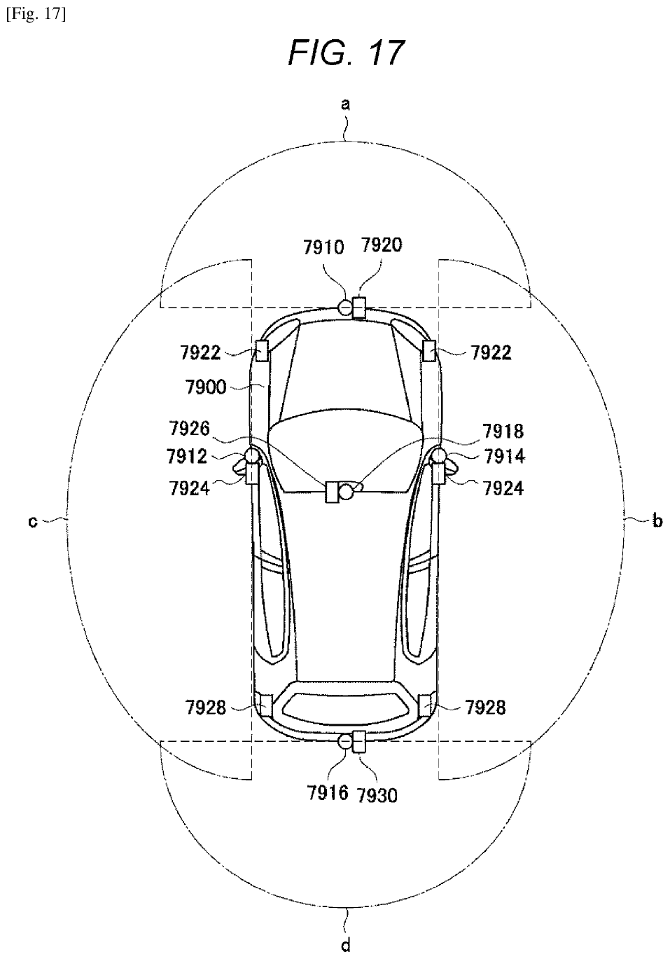

Here, FIG. 17 shows an example of installation positions of the image capturing units 7410 and the outside-vehicle information detecting units 7420. Image capturing units 7910, 7912, 7914, 7916, and 7918 are each provided at at least one of, for example, a front nose, side mirrors, a rear bumper, a back door, or an upper portion of a front glass in a compartment of a vehicle 7900. The image capturing unit 7910 provided at the front nose and the image capturing unit 7918 provided at the upper portion of the front glass in the compartment mainly acquire an image of an area in front of the vehicle 7900. The image capturing units 7912 and 7914 provided at side minors mainly acquire images of areas on both sides of the vehicle 7900. The image capturing unit 7916 provided at the rear bumper or the back door acquires an image of an area behind the vehicle 7900. The image capturing unit 7918 provided at the upper portion of the front glass in the compartment is used to mainly detect a preceding vehicle, a pedestrian, an obstacle, a traffic light, a traffic sign, a lane, or the like.

Note that FIG. 17 shows an example of shooting ranges of the respective image capturing units 7910, 7912, 7914, and 7916. An image capturing range a indicates an image capturing range of the image capturing unit 7910 provided at the front nose, image capturing ranges b and c indicate image capturing ranges of the image capturing units 7912 and 7914 provided at the side mirrors, respectively, and an image capturing range d indicates an image capturing range of the image capturing unit 7916 provided at the rear bumper or the back door. For example, pieces of image data captured by the image capturing units 7910, 7912, 7914, and 7916 are superimposed, thereby obtaining a bird's eye view image from above the vehicle 7900.

Outside-vehicle information detecting units 7920, 7922, 7924, 7926, 7928, and 7930 provided at the front, the rear, the sides, the corners, and the upper portion of the front glass in the compartment of the vehicle 7900, respectively, may be, for example, ultrasonic sensors or radar devices. The outside-vehicle information detecting units 7920, 7926, and 7930 provided at the front nose, the rear bumper, the back door, and the upper portion of the front glass in the compartment of the vehicle 7900, respectively, may be, for example, LIDAR devices. These outside-vehicle information detecting units 7920 to 7930 are used to mainly detect a preceding vehicle, a pedestrian, an obstacle, or the like.

Referring back to FIG. 16, the description will be continued. The outside-vehicle information detection unit 7400 causes the image capturing unit 7410 to capture an image of an area outside the vehicle, and receives the captured image data. Furthermore, the outside-vehicle information detection unit 7400 receives detection information from the connected outside-vehicle information detecting unit 7420. In a case where the outside-vehicle information detecting unit 7420 is an ultrasonic sensor, a radar device, or a LIDAR device, the outside-vehicle information detection unit 7400 sends ultrasonic waves or electromagnetic waves, and receives information of received reflected waves. The outside-vehicle information detection unit 7400 may perform processing of detecting an object such as a person, a vehicle, an obstacle, a sign, a character on a road surface, or the like, or distance detection processing on the basis of the received information. The outside-vehicle information detection unit 7400 may perform environment recognition processing of recognizing rain, fog, a road surface condition, or the like on the basis of the received information. The outside-vehicle information detection unit 7400 may calculate a distance to an object outside the vehicle on the basis of the received information.

Furthermore, the outside-vehicle information detection unit 7400 may perform image recognition processing of recognizing a person, a vehicle, an obstacle, a sign, a character on a road surface, or the like, or distance detection processing on the basis of the received image data. The outside-vehicle information detection unit 7400 may generate a bird's eye view image or a panorama image by performing processing such as distortion correction or position matching with respect to the received image data, and combining image data captured by a different image capturing unit 7410. The outside-vehicle information detection unit 7400 may perform view point conversion processing by using image data captured by a different image capturing unit 7410.

The inside-vehicle information detection unit 7500 detects information regarding an inside area of the vehicle. For example, a driver state detecting unit 7510 detecting a state of a driver is connected to the inside-vehicle information detecting unit 7500. The driver state detecting unit 7510 may include a camera capturing an image of a driver, a biosensor detecting biological information of the driver, a microphone collecting voice in the compartment, or the like. The biological sensor is provided at, for example, a seat surface, a steering wheel, or the like, and detects biological information of a passenger sitting on the seat surface or the driver holding the steering wheel. The inside-vehicle information detection unit 7500 may calculate a degree of fatigue or a degree of concentration of the driver, or determine whether or not the driver dozes off on the basis of detection information input from the driver state detecting unit 7510. The inside-vehicle information detection unit 7500 may perform processing such as noise canceling processing for a collected audio signal, or the like.

The integrated control unit 7600 controls an overall operation of the vehicle control system 7000 according to various programs. An input unit 7800 is connected to the integrated control unit 7600. The input unit 7800 is implemented by a device which can be subjected to an input operation by a passenger, such as, for example, a touch panel, a button, a microphone, a switch, a lever, or the like. Data obtained by recognizing voice input through a microphone may be input to the integrated control unit 7600. The input unit 7800 may be a remote control device using, for example, infrared rays or other electric waves, or may be an external connection device such as a mobile phone, a personal digital assistant (PDA), or the like corresponding to an operation of the vehicle control system 7000. The input unit 7800 may also be, for example, a camera, and in this case, the passenger can input information by using a gesture. Alternatively, data obtained by detecting a motion of a wearable device worn by the passenger may be input. Moreover, the input unit 7800 may include an input control circuit generating an input signal on the basis of, for example, information input by the passenger or the like using the input unit 7800, and outputting the input signal to the integrated control unit 7600. The passenger or the like operates the input unit 7800 to input various data to the vehicle control system 7000 or instruct a processing operation.

The storing unit 7690 may include a read only memory (ROM) storing various programs executed by a microcomputer, and a random access memory (RAM) storing various parameters, calculation results, or sensor values. Furthermore, the storing unit 7690 may be implemented by a magnetic storage device such as a hard disk drive (HDD) or the like, a semiconductor storage device, an optical storage device, a magneto-optical storage device, or the like.

The universal communication I/F 7620 is a common communication I/F for relaying communication with various devices present in the external environment 7750. The universal communication I/F 7620 may implement a cellular communication protocol such as a global system of mobile communications (GSM, registered trademark), a WiMAX (registered trademark), a long term evolution (LTE, registered trademark), an LTE-advanced (LTE-A), or the like, or other wireless communication protocols such as a wireless LAN (also called Wi-Fi (registered trademark)), Bluetooth (registered trademark), and the like. The universal communication I/F 7620 may be connected to a device (for example, an application server or a control server) present on an external network (for example, Internet, a cloud network, or a company-specific network) through, for example, a base station or an access point. Furthermore, the universal communication I/F 7620 may be connected to a terminal (for example, a terminal of a driver, a pedestrian, or a shop, or a machine type communication (MTC) terminal) present in the vicinity of a vehicle by using, for example, a peer to peer (P2P) technology.

The dedicated communication I/F 7630 is a communication I/F supporting a communication protocol set for the purpose of a use in a vehicle. The dedicated communication I/F 7630 may implement, for example, a wireless access in vehicle environment (WAVE) which is a combination of IEEE802.11p as a lower layer and IEEE1609 as a higher layer, dedicated short range communications (DSRC), or a cellular communication protocol as a standard protocol. The dedicated communication I/F 7630 typically performs V2X communication as a concept including one or more of vehicle to vehicle communication, vehicle to infrastructure communication, vehicle to home communication, and vehicle to pedestrian communication.

The positioning unit 7640 executes positioning by receiving a global navigation satellite system (GNSS) signal (for example, a GPS signal from a GPS satellite) from a GNSS satellite, and generates position information including the latitude, the longitude, and an altitude of a vehicle. Note that the positioning unit 7640 may specify a current position by exchanging a signal with a wireless access point, or may acquire position information from a terminal such as a mobile phone, a PHS, or a smartphone having a positioning function.

The beacon receiving unit 7650 receives electric waves or electromagnetic waves sent from, for example, a radio station installed on a road, or the like, to acquire information such as a current position, a traffic jam, a curfew, a time required, or the like. Note that the function of the beacon receiving unit 7650 may be included in the dedicated communication I/F 7630 described above.

The in-vehicle equipment I/F 7660 is a communication interface relaying connection between the microcomputer 7610 and various pieces of in-vehicle equipment 7760 present in a vehicle. The in-vehicle equipment I/F 7660 may establish wireless connection by using a wireless communication protocol such as a wireless LAN, Bluetooth (registered trademark), near field communication (NFC), or a wireless universal serial bus (WUSB). Furthermore, the in-vehicle equipment I/F 7660 may establish wired connection of a universal serial bus (USB), a high-definition multimedia interface (HDMI, registered trademark), a mobile high-definition link (MHL), or the like through a connection terminal (not shown) (and a cable as necessary). The in-vehicle equipment 7760 may include at least one of, for example, mobile equipment or wearable equipment of a passenger, or information equipment brought into or attached to a vehicle. Furthermore, the in-vehicle equipment 7760 may include a navigation device performing a route search to a certain destination. The in-vehicle equipment I/F 7660 exchanges a control signal or a data signal with these pieces of in-vehicle equipment 7760.

The in-vehicle network I/F 7680 is an interface relaying communication between the microcomputer 7610 and the communication network 7010. The in-vehicle network I/F 7680 transmits and receives a signal or the like according to a predetermined protocol supported by the communication network 7010.

The microcomputer 7610 of the integrated control unit 7600 controls the vehicle control system 7000 according to various programs on the basis of information acquired through at least one of the universal communication I/F 7620, the dedicated communication I/F 7630, the positioning unit 7640, the beacon receiving unit 7650, the in-vehicle equipment I/F 7660, or the in-vehicle network I/F 7680. For example, the microcomputer 7610 may calculate a target control value of a driving generation device, a steering mechanism, or a brake device on the basis of the acquired information regarding the inside area and the outside area of the vehicle, and output a control instruction to the driving system control unit 7100. For example, the micro-computer 7610 may perform a cooperative control for the purpose of implementing functions of an advanced driver assistance system (ADAS) including vehicle collision avoidance, impact alleviation, following traveling based on an inter-vehicle distance, traveling while maintaining a vehicle speed, a vehicle collision warning, or a vehicle lane departure warning. Furthermore, the microcomputer 7610 may perform a cooperative control for the purpose of an automatic driving in which a vehicle autonomously travels without an operation by a driver or the like by controlling a driving generation device, a steering mechanism, or a brake device on the basis of acquired surrounding information of the vehicle.

The microcomputer 7610 may generate information regarding a three-dimensional distance between a vehicle and an object such as a structure or a person around the vehicle on the basis of information acquired through at least one of the universal communication I/F 7620, the dedicated communication I/F 7630, the positioning unit 7640, the beacon receiving unit 7650, the in-vehicle equipment I/F 7660, or the in-vehicle network I/F 7680, and create local map information including surrounding information of a current position of the vehicle. Furthermore, the microcomputer 7610 may predict a risk such as vehicle collision, proximity of a pedestrian or the like, entering into a road during a curfew, or the like on the basis of the acquired information, and generate a warning signal. The warning signal may be, for example, a signal for generating a warning sound or lighting a warning lamp.

The voice and image output unit 7670 transmits an output signal of at least one of voice and an image to an output device which is capable of visually or acoustically notifying a passenger of a vehicle or an outside area of the vehicle of information. In the example in FIG. 16, an audio speaker 7710, a display unit 7720, and an instrument panel 7730 are illustrated as the output devices. The display unit 7720 may include at least one of, for example, an on-board display or a head-up display. The display unit 7720 may have an augmented reality (AR) display function. The output device may be a device other than the devices described above, such as a wearable device including headphones, a glasses type display worn by a passenger, or the like, a projector, a lamp, or the like. In a case where the output device is a display device, the display device visually displays a result and information in various forms such as a text, an image, a table, a graph, or the like, the result being obtained by various pieces of processing performed by the microcomputer 7610 and the information being received from another control unit. Furthermore, in a case where the output device is a voice output device, the voice output device converts an audio signal including data of reproduced voice or sound into an analog signal, and visually outputs the analog signal.

Note that in the example shown in FIG. 16, at least two control units connected to each other through the communication network 7010 may be integrated as one control unit. Alternatively, each control unit may be configured by a plurality of control units. Moreover, the vehicle control system 7000 may include a different control unit (not shown). Furthermore, another control unit may have a part or all of functions of a certain control unit in the above description. That is, if transmission and reception of information are performed through the communication network 7010, predetermined calculation processing may be performed by a certain control unit. Similarly, a sensor or a device connected to a certain control unit may be connected to another control unit, and a plurality of control units may mutually transmit and receive detection information through the communication network 7010.

A computer program for implementing respective functions of the integrated control unit 7600 according to the present embodiment can be installed in a certain control unit, or the like. Furthermore, it is possible to provide a computer-readable recording medium in which the computer program is stored. The recording medium is, for example, a magnetic disk, an optical disk, a magneto-optical disk, a flash memory, or the like. Furthermore, the computer program may be distributed through, for example, a network without using the recording medium.

The vehicle control system 7000 described above can perform processing of detecting an object such as a person, a vehicle, an obstacle, a sign, or a character on a road surface, or distance detection processing on the basis of image data obtained by image capturing performed by the image capturing unit 7410.

However, in a case where image analysis processing (specifically, the object detection processing or the distance detection processing) in the later stage is performed for all captured image data, a load of the processing is increased.

In this regard, the technology according to the present disclosure is applied to the vehicle control system 7000, thereby decreasing a load of the image analysis processing.

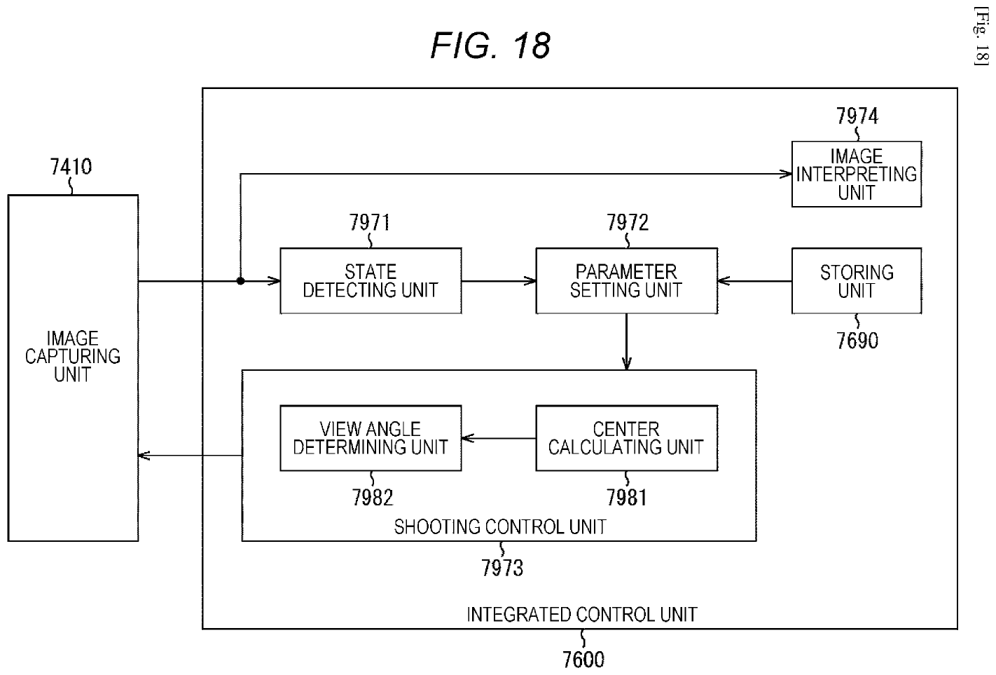

FIG. 18 is a block diagram showing an example of a functional configuration of the integrated control unit 7600 to which the technology according to the present disclosure is applied.

Note that in FIG. 18, a configuration which is similar to the configuration described with reference to FIG. 16 will be denoted by the same reference numeral and a description thereof will be omitted.

The integrated control unit 7600 in FIG. 18 includes a state detecting unit 7971, a parameter setting unit 7972, and a shooting control unit 7973.

The state detecting unit 7971 detects a state of each of a person, a bicycle, another vehicle, an obstacle, a road sign, and a road marking in image data (on-vehicle camera video) obtained from the image capturing unit 7410.

The parameter setting unit 7972 acquires a parameter (weighting factor) corresponding to a state of a detection target from the storing unit 7690 by using a result of the state detection performed by the state detecting unit 7971 and sets the parameter for each detection target in the on-vehicle camera video.

The shooting control unit 7973 controls a shooting range of the image capturing unit 7410 on the basis of the weighting factor which corresponds to the state of the detection target and is set by the parameter setting unit 7972. Note that a center calculating unit 7981 and a view angle determining unit 7982 included in the shooting control unit 7973 have functions similar to those of the center calculating unit 81 and the view angle determining unit 82 in FIG. 5, respectively, and thus a description thereof will be omitted.

An image obtained according to the control of the shooting range by the shooting control unit 7973 is supplied to an image analysis unit 7974, and the object detection processing or the distance detection processing is performed.

In the integrated control unit 7600, a shooting control for decreasing a load of the image analysis processing in the later stage is performed in accordance with a state of a detection target.

Specifically, a state of a person, a bicycle, an automobile, or a vehicle around a host vehicle in an on-vehicle camera video is detected, a weighting factor corresponding to the detected state is set, and a shooting control related to the image analysis processing in the later stage is performed on the basis of a result of the setting.

For example, image data cropped on the basis of the weighting factor set for each detection target in the on-vehicle camera video is supplied to the image analysis unit 7974. With this arrangement, the image analysis processing is performed for only a necessary region, such that it is possible to decrease a load of the image analysis processing.

Furthermore, image data, in which a region cropped in the on-vehicle camera video has high resolution and remaining regions has low resolution, may be supplied to the image analysis unit 7974, rather than cropping the on-vehicle camera video.

As a state of the detection target, examples of a state of a person include at least one of walking, running, or stopping, and examples of a state of a bicycle include at least one of traveling straight or meandering. Furthermore, examples of a state of an automobile include at least one of inclined traveling, meandering, or traveling near a white line on a road. Moreover, examples of a state of a vehicle around a host vehicle include at least one of an approach to the host vehicle, cutting in, a lane change, or a right turn or a left turn (crossing in a movement direction of the host vehicle) of an opposite vehicle at an intersection.

For example, an accident rate is high in a case where a running person or bicycle is present around the host vehicle, and the accident rate is low in a case where only a walking person is present around the host vehicle. Therefore, as a weighting factor corresponding to the state of the person or bicycle, a weighting factor with a large value is set for a running person or bicycle, and a weighting factor with a small value is set for a walking person. With this arrangement, it is possible to calculate a distance to, for example, a detection target which is likely to cause an accident at a low load.

Moreover, as a weighting factor corresponding to the state of the bicycle, a weighting factor with a large value is set for a meandering bicycle, and a weighting factor with a small value is set for a bicycle traveling straight. With this arrangement, it is possible to calculate a distance to an unstably traveling bicycle which is likely to cause an accident at a low load.

Furthermore, as a weighting factor corresponding to the state of the automobile, a weighting factor with a large value is set for an automobile traveling in the vicinity of a white line of a road, and a weighting factor with a small value is set for an automobile traveling between white lines. With this arrangement, it is possible to calculate a distance to an automobile which travels while weaving between vehicles and thus is likely to cause an accident at a low load.

Moreover, as a weighting factor corresponding to the state of the vehicle around the host vehicle, a weighting factor with a large value is set for a vehicle approaching the host vehicle, and a weighting factor with a small value is set for a vehicle traveling away from the host vehicle. With this arrangement, it is possible to calculate a distance to an automobile which tries to enter the same lane as that of the host vehicle by a lane change and thus is likely to cause an accident at a low load.

Furthermore, as a weighting factor corresponding to a state appearance order of a detection target, in a case where a state of a person or a bicycle which is likely to cause an accident as described above is detected after a presence of an intersection (a traffic light or a road marking) is recognized, a weighting factor with a larger value may be set.

According to the configuration described above, a weighting factor corresponding to a state of each of a plurality of detection targets in an on-vehicle camera video is set for each detection target, and thus it is possible to put an important detection target which should receive attention in the on-vehicle camera video within a shooting range.

### (Example of Application to Endoscopic Operation System)

The technology (the present technology) according to the present disclosure may be applied to an endoscopic operation system.

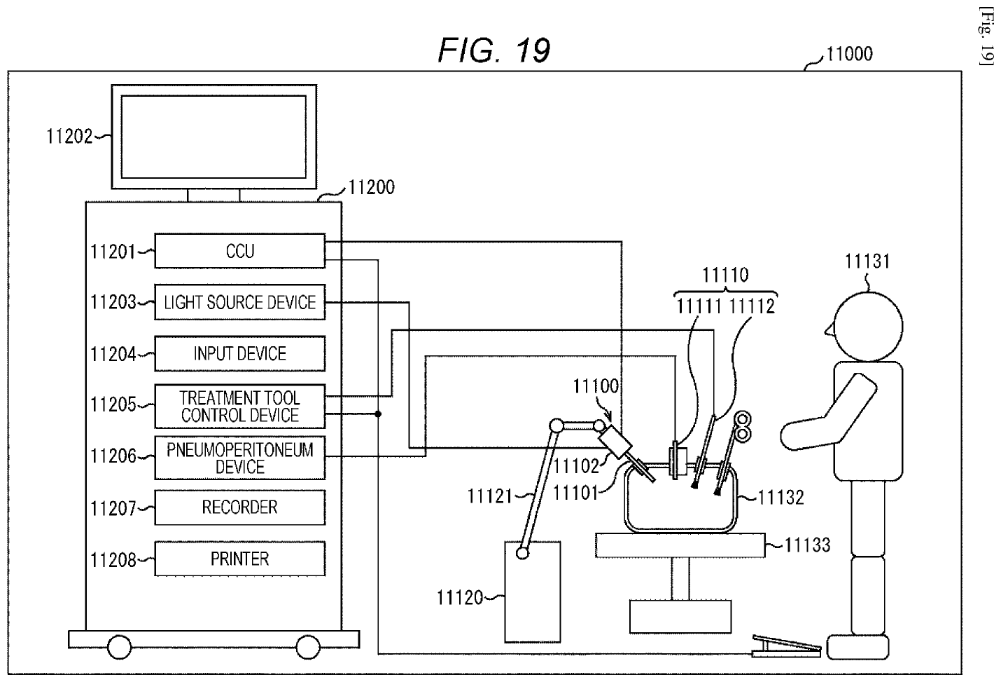

FIG. 19 is a diagram showing an example of a schematic configuration of an endoscopic operation system to which the technology (the present technology) according to the present disclosure can be applied.

FIG. 19 shows a situation in which an operator (surgeon) 11131 performs an operation on a patient 11132 on a patient bed 11133 by using an endoscopic operation system 11000. As shown in FIG. 19, the endoscopic operation system 11000 includes an endoscope 11100, other operation tools 11110 such as a pneumoperitoneum tube 11111, an energy treatment tool 11112, or the like, a support arm device 11120 supporting the endoscope 11100, and a cart 11200 in which various devices for an endoscopic operation are loaded.

The endoscope 11100 includes a lens barrel 11101 of which a region having a predetermined length from a tip end is inserted into the body cavity of the patient 11132, and a camera head 11102 connected to a base end of the lens barrel 11101. In the example shown in FIG. 19, the endoscope 11100 implemented as a so called solid mirror including the solid lens barrel 11101 is shown, but the endoscope 11100 may also be implemented as a so called flexible mirror including a flexible lens barrel.

An opening in which an object lens is fitted is provided in the tip end of the lens barrel 11101. A light source device 11203 is connected to the endoscope 11100, and light generated by the light source device 11203 is guided to the tip end of the lens barrel by a light guide extending in the inside of the corresponding lens barrel 11101, and applied to an observation target in the body cavity of the patient 11132 through the object lens. Note that the endoscope 11100 may be a forward view endoscope, an oblique view endoscope, or a side view endoscope.

An optical system and an image capturing element are provided in the camera head 11102, and reflected light (observation light) from the observation target is collected to the image capturing element by the optical system. The observation light is photoelectrically transformed by the image capturing element, and an electric signal corresponding to the observation light, that is, an image signal corresponding to an observation image is generated. The image signal is transmitted as RAW data to a camera control unit (CCU) 11201.

The CCU 11201 includes a central processing unit (CPU), a graphics processing unit (GPU), and the like, and generally controls operations of the endoscope 11100 and a display device 11202. Moreover, the CCU 11201 receives an image signal from the camera head 11102 and performs, with respect to the image signal, various pieces of image processing for displaying an image based on the image signal, such as, for example, development processing (mosaic processing) or the like.

The display device 11202 displays an image based on the image signal subjected to the image processing by the CCU 11201 according to the control by the CCU 11201.

The light source device 11203 includes a light source such as, for example, a light emitting diode (LED) or the like, and supplies, to the endoscope 11100, irradiation light at the time of shooting a operational site or the like.

The input device 11204 is an input interface for the endoscopic operation system 11000. A user can input various pieces of information or an instruction to the endoscopic operation system 11000 through the input device 11204. For example, the user inputs an instruction to change a shooting condition (a type of irradiation light, magnification, a focal length, and the like) of the endoscope 11100, or the like.

A treatment tool control device 11205 controls driving of the energy treatment tool 11112 for cauterizing tissues, making an incision, sealing a blood vessel, or the like. In order to inflate the body cavity of the patient 11132 for the purpose of securing a visual field of the endoscope 11100 or a working space of the operator, the pneumoperitoneum device 11206 sends gas into the body cavity through the pneumoperitoneum tube 11111. A recorder 11207 is a device which is capable of recording various pieces of information associated with the operation. A printer 11208 is a device which is capable of printing various pieces of information associated with the operation in various forms such as a text, an image, a graph, and the like.

Note that the light source device 11203 supplying the irradiation light at the time of shooting the operational site by the endoscope 11100 can include a white light source implemented by, for example, an LED, a laser light source, or a combination thereof. In a case where the white light source is implemented by a combination of red, green, and blue (RGB) laser light sources, since an output intensity and an output timing of each color (each wavelength) can be controlled with high precision, it is possible to adjust white balance of a captured image in the light source device 11203. Furthermore, in this case, laser light from each of the RGB laser light sources is applied to the observation target in a time-division manner, and driving of the image capturing element of the camera head 11102 is controlled in synchronization with the irradiation timing, such that it is possible to capture an image corresponding to each of RGB in a time-division manner. According to the above-described method, it is possible to obtain a color image without providing a color filter in the corresponding image capturing element.

Furthermore, driving of the light source device 11203 may be controlled so that an intensity of output light is changed at each predetermined time. Driving of the image capturing element of the camera head 11102 is controlled in synchronization with a timing of a change of the light intensity to acquire an image in a time-division manner, and the image is synthesized, such that it is possible to generate an image with a high dynamic range and without so called blown out highlights and blocked up shadows.

Furthermore, the light source device 11203 may be configured to be able to supply light in a predetermined wavelength band corresponding to specific light observation. In the special light observation, for example, light in a narrower band in comparison to that of irradiation light (in other words, white light) at the time of general observation is applied by using a dependence of light absorption of a body tissue on a wavelength, such that a so called narrow band imaging, in which a predetermined tissue such as a blood vessel of a mucous membrane surface layer or the like is shot with high contrast, is performed. Alternatively, in the special light observation, fluorescence observation in which an image is obtained by fluorescence generated by application of excited light may be performed. In the fluorescence observation, it is possible to observe fluorescence from a body tissue by applying excited light to the body tissue (self-fluorescence observation), to obtain a fluorescence image by locally injecting a reagent such as indocyanine (ICG) or the like into a body tissue and applying excited light corresponding to a fluorescence wavelength of the reagent to the corresponding body tissue, or the like. The light source device 11203 can be configured to be able to supply light in a narrow band and/or excited light corresponding to the special light observation described above.

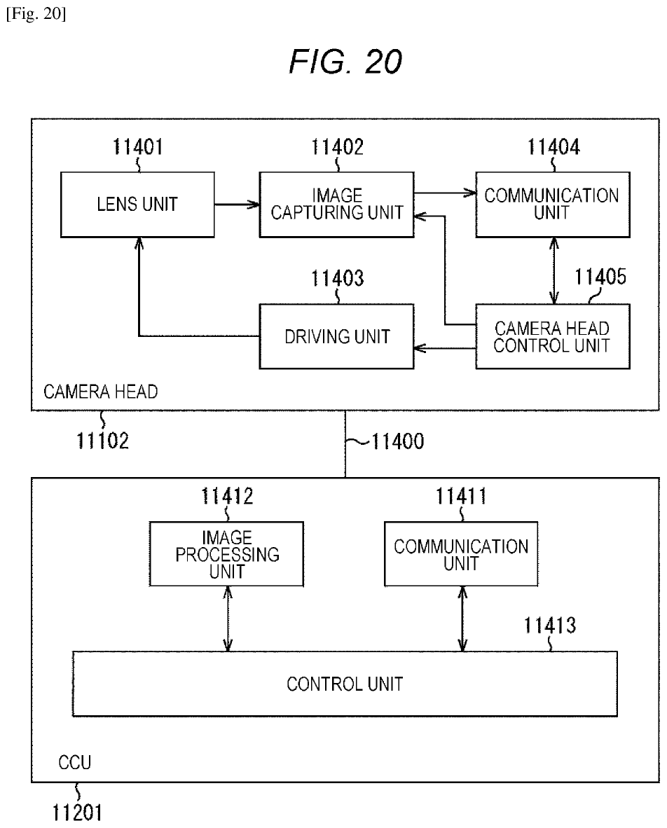

FIG. 20 is a block diagram showing an example of functional configurations of the camera head 11102 and the CCU 11201 shown in FIG. 19.

The camera head 11102 includes a lens unit 11401, an image capturing unit 11402, a driving unit 11403, a communication unit 11404, and a camera head control unit 11405. The CCU 11201 includes a communication unit 11411, an image processing unit 11412, and a control unit 11413. The camera head 11102 and the CCU 11201 are mutually communicably connected to each other by a transmission cable 11400.

The lens unit 11401 is an optical system provided in a portion of the camera head 11102 connected to the lens barrel 11101. Observation light introduced from the tip end of the lens barrel 11101 is guided to the camera head 11102 and is incident to the lens unit 11401. The lens unit 11401 includes an assembly of a plurality of lenses including a zoom lens and a focus lens.

The number of image capturing elements constituting the image capturing unit 11402 may be one (so called single-plate type) or plural (so called multi-plate type). In a case where the image capturing unit 11402 includes a multi-plate type, for example, a color image may be obtained by generating image signals corresponding to RGB, respectively, by each image capturing element, and synthesizing the image signals. Alternatively, the image capturing unit 11402 may also include a pair of image capturing elements for acquiring each of an image signal for the right eye and an image signal for the left eye corresponding to a three-dimensional (3D) display. As the 3D display is performed, the operator 11131 can more accurately grasp a depth of a biological tissue in an operational site. Note that in a case where the image capturing unit 11402 includes a multi-plate type, a plurality of lens units 11401 can be provided, corresponding to the respective image capturing elements.

Furthermore, the image capturing unit 11402 may not necessarily be provided in the camera head 11102. For example, the image capturing unit 11402 may also be provided inside the lens barrel 11101 right behind the object lens.

The driving unit 11403 is implemented by an actuator and moves only a predetermined distance along an optical axis of the zoom lens and the focus lens of the lens unit 11401 according to a control by the camera head control unit 11405. With this arrangement, it is possible to appropriately adjust magnification and focus of an image captured by the image capturing unit 11402.

The communication unit 11404 is implemented by a communication device for transmitting and receiving various pieces of information to and from the CCU 11201. The communication unit 11404 transmits an image signal obtained from the image capturing unit 11402 as RAW data to the CCU 11201 through the transmission cable 11400.

Furthermore, the communication unit 11404 receives a control signal for controlling the driving of the camera head 11102 from the CCU 11201, and supplies the received control signal to the camera head control unit 11405. The control signal includes information related to image capturing conditions, such as, for example, information for specifying a frame rate of a captured image, information for specifying an exposure value at the time of image capturing, and/or information for specifying magnification and focus of a captured image.

Note that the image capturing conditions such as the frame rate, the exposure value, the magnification, the focus, and the like may be appropriately specified by a user, or may be automatically set by the control unit 11413 of the CCU 11201 on the basis of the acquired image signal. In the case of the automatic setting, the endoscope 11100 has a so called auto exposure (AE) function, an auto focus (AF) function, and an auto white balance (AWB) function.

The camera head control unit 11405 controls the driving of the camera head 11102 on the basis of the control signal received from the CCU 11201 through the communication unit 11404.

The communication unit 11411 is implemented by a communication device for transmitting and receiving various pieces of information to and from the camera head 11102. The communication unit 11411 receives an image signal transmitted from the camera head 11102 through the transmission cable 11400.

Furthermore, the communication unit 11411 transmits, to the camera head 11102, a control signal for controlling the driving of the camera head 11102. The image signal or the control signal can be transmitted through electric communication, optical communication, or the like.

The image processing unit 11412 performs various pieces of image processing for the image signal as RAW data transmitted from the camera head 11102.

The control unit 11413 performs various controls related to image capturing of an operational site or the like by the endoscope 11100, and a display of a captured image obtained by the image capturing of the operational site or the like. For example, the control unit 11413 generates a control signal for controlling the driving of the camera head 11102.

Furthermore, the control unit 11413 controls the display device 11202 to display a captured image in which an operational site or the like is reflected on the basis of the image signal subjected to the image processing by the image processing unit 11412. At this time, the control unit 11413 may recognize various objects in the captured image by using various image recognition technologies. For example, the control unit 11413 can recognize an operation tool such as forceps or the like, a specific part of a living body, bleeding, mist at the time of using the energy treatment tool 11112, or the like by detecting a shape, a color, or the like of an edge of an object included in the captured image. The control unit 11413 may control the display device 11202 to display various pieces of operation support information in an overlapping manner by using a result of the recognition at the time of displaying the captured image on the display device 11202. As the operation support information is displayed in an overlapping manner and presented to the operator 11131, it is possible to decrease a load on the operator 11131 and the operator 11131 can surely proceed with the operation.

The transmission cable 11400 connecting the camera head 11102 and the CCU 11201 is an electric signal cable corresponding to electric signal communication, an optical fiber corresponding to optical communication, or a composite cable thereof.

Here, although wired communication using the transmission cable 11400 is performed in the example shown in the drawing, the communication between the camera head 11102 and the CCU 11201 may also be wireless communication.

In the related art, it has been necessary to place the camera head near an operational site at the time of enlarging an operational field (a portion shown as an operation target) in an endoscopic operation. In this case, it is difficult for the operator to simultaneously check an enlarged video of the operational site and a whole image of the operational field, and furthermore, there is a possibility that the camera head and the operation tool come into contact with each other.

For this, in recent years, a method, in which a clearer video is obtained by a digital zoom function or a crop function while performing shooting at a position slightly distant from an operational site by using a high-resolution camera such as an 8K resolution camera or the like, has been suggested.

However, in an endoscope system using a high-resolution camera, it is necessary for an operator (operating surgeon) to instruct a staff to perform enlargement processing in order to obtain an enlarged video, and thus the operating surgeon cannot proceed with a medical procedure until the instruction is delivered to the staff. Accordingly, there is a possibility that the operation is delayed.

In this regard, the technology according to the present disclosure is applied to the endoscopic operation system 11000, thereby solving the operation delay problem.

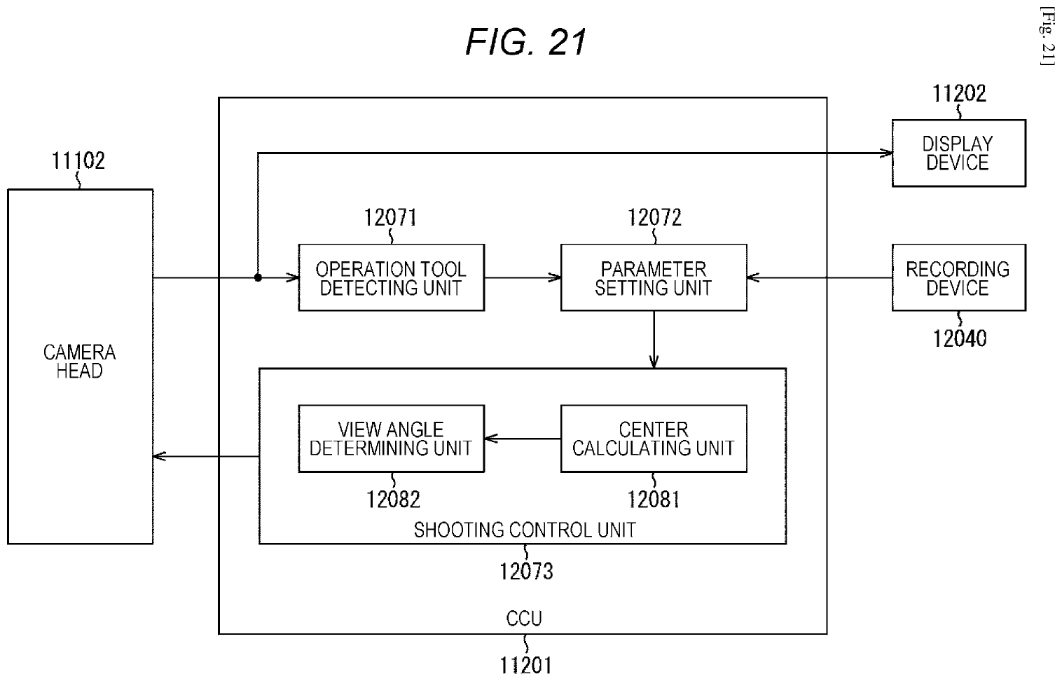

FIG. 21 is a block diagram showing an example of a functional configuration of the CCU 11201 to which the technology according to the present disclosure is applied.

Note that in FIG. 21, a configuration which is similar to the configuration described with reference to FIG. 20 will be denoted by the same reference numeral and a description thereof will be omitted.

The CCU 11201 in FIG. 21 includes an operation tool detecting unit 12071, a parameter setting unit 12072, and a shooting control unit 12073.

The operation tool detecting unit 12071 detects a state of each of operation tools in an image signal (operational field video) from the camera head 11102.

The parameter setting unit 12072 acquires a parameter (weighting factor) corresponding to a state of an operation tool from a storing unit 12040 by using a result of the state detection performed by the operation tool detecting unit 12071 and sets the parameter for each operation tool in the operational field video.

The shooting control unit 12073 controls a shooting range of the camera head 11102 on the basis of the weighting factor which corresponds to the state of the operation tool and is set by the parameter setting unit 12072. Note that a center calculating unit 12081 and a view angle determining unit 12082 included in the shooting control unit 12073 have functions similar to those of the center calculating unit 81 and the view angle determining unit 82 in FIG. 5, respectively, and thus a description thereof will be omitted.

An enlarged video which is obtained according to the control of the shooting range by the shooting control unit 12073 is controlled by the shooting control unit 12073 and in which an operation site, an operation tool, or the like is reflected is displayed on the display device 11202.

In the endoscopic operation, an operation in which a target resection portion is exposed by using grip forceps and the exposed target resection portion is resected with a radio knife is performed. Therefore, in the CCU 11201 to which the technology according to the present disclosure is applied, the shooting range is controlled in accordance with the state of the grip forceps or the radio knife. Here, an example of application in which the present technology is applied to an endoscopic operation system using a radio knife will be described, but the present disclosure is not limited thereto, and the present technology can also be applied to an endoscopic operation system using an energy treatment tool such as an ultrasonic scalpel, a laser scalpel, or the like.

Specifically, a state of grip forceps or a radio knife in an operational field video is detected, a weighting factor corresponding to the detected state is set, and a shooting view angle of an enlarged video is controlled on the basis of a result of the setting.

As a weighting factor corresponding to each of states of these operation tools, for example, a weighting factor with a larger value than that of grip forceps is set for a radio knife. With this arrangement, the operator can proceed with a medical procedure while checking the enlarged video in accordance with the procedure of the endoscopic operation described above.

Furthermore, in a case where a radio knife is detected after grip forceps are detected, a weighting factor with a larger value may be set as a weighting factor corresponding to an operation tool appearance order. For example, in preparation before resection such as expanding an operational field by using first grip forceps, applying counter tension by using second grip forceps, or the like, when it is necessary to perform a treatment on a wide range, a wide visual field in which a plurality of grip forceps are included is set as the shooting range. Furthermore, thereafter, a radio knife is detected, and when it is necessary to perform a treatment requiring high precision such as resection of a site of lesion, or the like, a view of an area around the radio knife is enlarged and is set as the shooting range.

According to the configuration described above, a weighting factor corresponding to a state of each of a plurality of operation tools in an operational field video is set for each operation tool, and thus it is possible to put an important operation tool which should receive attention in the operational field image within a shooting range.

Note that the embodiment of the present disclosure is not limited to those described above, and may be variously changed without departing from the gist of the present disclosure.

Furthermore, the effects described in the present specification are merely illustrative and not limitative, and the present disclosure may have other effects.

Moreover, the present disclosure can have the following configuration.

(1) An image processing device, including:
a parameter setting unit that sets a parameter corresponding to a state of each of a plurality of subjects in a video for each subject of which at least a state is detected; and
a shooting control unit that controls a shooting range of the video obtained by a shooting device, on the basis of the parameter set for each subject.

(2) The image processing device according to (1), in which
the parameter setting unit sets the parameter corresponding to an action of each of a plurality of persons in the video for each person.

(3) The image processing device according to (2), in which
the action of the persons is a motion which is performable by the person during a lecture.

(4) The image processing device according to (3), in which
the motion which is performable by the person during the lecture includes at least one of standing-up, seat-taking, or hand-raising.

(5) The image processing device according to (2) to (4), in which
the parameter setting unit sets a first weighting factor defined for each action type as the parameter for each person, and
the shooting control unit determines a center of the shooting range on the basis of the first weighting factor set for each person.

(6) The image processing device according to (5), in which
the parameter setting unit sets a second weighting factor defined for each action appearance order as the parameter for each person, and
the shooting control unit determines the center and a size of the shooting range on the basis of the first weighting factor and the second weighting factor set for each person.

(7) The image processing device according to (6), in which
the shooting control unit determines the size of the shooting range so that a whole body of the person of which a product of the first weighting factor and the second weighting factor is largest is put within the shooting range.

(8) The image processing device according to (2) to (7), in which
the shooting control unit controls a shooting view angle of the shooting device on the basis of the parameter set for each person.

(9) The image processing device according to (8), in which
the shooting device includes a PTZ camera, and
the shooting control unit controls panning, tilting, and zooming of the shooting device.

(10) The image processing device according to (9), in which
the shooting control unit controls the zooming of the shooting device on the basis of distance information associated with the person in the video.

(11) The image processing device according to (2) to (7), in which
the shooting control unit controls a cut-out range of the video on the basis of the parameter set for each person.

(12) The image processing device according to (11), in which
the shooting device includes a wide-angle camera.

(13) The image processing device according to (2) to (12), in which
the parameter setting unit sets the parameter corresponding to a state of each of a plurality of objects reflected together with a plurality of the persons in the video for each object.

(14) The image processing device according to (1) to (13), in which
the video is an operational field video, and
the parameter setting unit sets the parameter corresponding to a state of each of a plurality of operation tools in the operational field video for each operation tool.

(15) The image processing device according to (1), in which
the video is an observation video of a biological sample, and
the parameter setting unit sets the parameter corresponding to a behavior of each of a plurality of the biological samples in the observation video for each biological sample.

(16) The image processing device according to (15), in which
the biological sample is a cell, and
a behavior of the cell includes at least one of a beat, division, fusion, bonding, deformation, or movement.

(17) The image processing device according to (1), in which
the video is an on-vehicle camera video, and
the parameter setting unit sets the parameter corresponding to a state of each of a person and a bicycle in the on-vehicle camera video for each of the person and the bicycle.

(18) The image processing device according to (17), in which
the state of the person includes at least one of walking, running, or stopping, and
the state of the bicycle includes at least one of traveling straight or meandering.

(19) An image processing method, including:
setting, by an image processing device, a parameter corresponding to a state of each of a plurality of subjects in a video for each subject of which at least a state is detected; and
controlling, by the image processing device, a shooting range of the video obtained by a shooting device, on the basis of the parameter set for each subject.

(20) A program for causing a computer to execute processing that includes:
setting a parameter corresponding to a state of each of a plurality of subjects in a video for each subject of which at least a state is detected; and
controlling a shooting range of the video obtained by a shooting device, on the basis of the parameter set for each subject.

(21) An image processing device, comprising:
circuitry configured to
detect states of a plurality of subjects in a first image;
set parameters corresponding to the detected states of the plurality of subjects; and
determine, on a basis of a combination of the parameters set for the plurality of subjects, an output range to obtain a second image.

(22) The image processing device according to (21), wherein the plurality of subjects includes a plurality of persons in the first image, and
the circuitry is configured to set each of the parameters on a basis of an action of a corresponding person of the plurality of persons in the first image.

(23) The image processing device according to (21) or (22), wherein the action of the corresponding person is a motion which is performed by the corresponding person during a lecture.

(24) The image processing device according to any one of (21) to (23), wherein the motion performed by the corresponding person during the lecture includes at least one of standing-up, seat-taking, or hand-raising.

(25) The image processing device according to any one of (21) to (24), wherein
the circuitry is configured to set a first weighting factor, for each of the parameters, on a basis of a type of the action of the corresponding person of the plurality of persons in the first image, and
the circuitry is configured to determine a center of the second image on a basis of the first weighting factor set for each of the parameters.

(26) The image processing device according to any one of (21) to (25), wherein the circuitry is configured to set a second weighting factor, for each of the parameters, on a basis of an appearance order of the action of the corresponding person of the plurality of persons in the first image, and
the circuitry is configured to determine the center of the second image on a basis of the first weighting factor and the second weighting factor set for each of the parameters.

(27) The image processing device according to any one of (21) to (26), wherein the circuitry is configured to determine the output range of the second image so that a person corresponding to one of the parameters having a largest product of the first weighting factor and the second weighting factor is within the second image.

(28) The image processing device according to any one of (21) to (27), wherein the circuitry is configured to control a shooting view angle of the shooting device on a basis of the parameters.

(29) The image processing device according to any one of (21) to (28), wherein the shooting device includes a PTZ camera, and
the circuitry is configured to control panning, tilting, and zooming of the shooting device.

(30) The image processing device according to any one of (21) to (29), wherein the circuitry is configured to control the zooming of the shooting device on a basis of distance information associated with at least one person of the plurality of persons in the first image.

(31) The image processing device according to any one of (21) to (30), wherein the circuitry is configured to determine a cropping range to obtain the second image.

(32) The image processing device according to any one of (21) to (31), wherein the shooting device includes a wide-angle camera.

(33) The image processing device according to any one of (21) to (32), wherein the plurality of subjects includes at least one person and at least one object included in the first image.

(34)The image processing device according to any one of (21) to (33), wherein the first image is in an operational field video, and
the plurality of subjects includes a plurality of operation tools in the operational field video.

(35)The image processing device according to any one of (21) to (34), wherein the first image is in an observation video of a plurality of biological samples,
the plurality of subjects includes the plurality of biological samples, and
the detected states of the plurality of subjects are behaviors of the plurality of biological samples.

(36) The image processing device according to any one of (21) to (35), wherein the biological samples are cells, and
the behaviors of the cells include at least one of a beat, division, fusion, bonding, deformation, or movement.

(37)The image processing device according to any one of (21) to (36), wherein the first image is in an on-vehicle camera video, and
the plurality of subjects includes at least one person and at least one bicycle in the on- vehicle camera video.

(38)The image processing device according to any one of (21) to (37), wherein the state of the person includes one of walking, running, or stopping, and
the state of the bicycle includes one of traveling straight or meandering.

(39) An image processing method, comprising:
detecting states of a plurality of subjects in a first image;
setting, by an image processing device, parameters corresponding to the detected states of the plurality of subjects; and
determining, by the image processing device and on a basis of a combination of the parameters set for the plurality of subjects, an output range to obtain a second image.

(40) A non-transitory computer-readable storage medium storing computer-readable instructions thereon, which, when executed by a computer, cause the computer to execute a method comprising:
detecting states of a plurality of subjects in a first image;
setting parameters corresponding to the detected states of the plurality of subjects; and
determining, on a basis of a combination of the parameters set for the plurality of subjects, an output range to obtain a second image.

### REFERENCE SIGNS LIST

10 Shooting device
20 Image processing device
30 Input and output device
40 Recording device
51 State detecting unit
52 Parameter setting unit
53 Shooting control unit
71 Action detecting unit
72 Parameter setting unit
73 Shooting control unit
81 Center calculating unit
82 View angle determining unit

1. An image processing device, comprising:
circuitry configured to
detect states of a plurality of subjects in a first image;
set parameters corresponding to the detected states of the plurality of subjects; and
determine, on a basis of a combination of the parameters set for the plurality of subjects, an output range to obtain a second image.

2. The image processing device according to claim 1, wherein
the plurality of subjects includes a plurality of persons in the first image, and
the circuitry is configured to set each of the parameters on a basis of an action of a corresponding person of the plurality of persons in the first image.

3. The image processing device according to claim 2, wherein
the action of the corresponding person is a motion which is performed by the corresponding person during a lecture.

4. The image processing device according to claim 3, wherein
the motion performed by the corresponding person during the lecture includes at least one of standing-up, seat-taking, or hand-raising.

5. The image processing device according to claim 2, wherein
the circuitry is configured to set a first weighting factor, for each of the parameters, on a basis of a type of the action of the corresponding person of the plurality of persons in the first image , and
the circuitry is configured to determine a center of the second image on a basis of the first weighting factor set for each of the parameters.

6. The image processing device according to claim 5, wherein
the circuitry is configured to set a second weighting factor, for each of the parameters, on a basis of an appearance order of the action of the corresponding person of the plurality of persons in the first image, and the circuitry is configured to determine the center of the second image on a basis of the first weighting factor and the second weighting factor set for each of the parameters.

7. The image processing device according to claim 6, wherein
the circuitry is configured to determine the output range of the second image so that a person corresponding to one of the parameters having a largest product of the first weighting factor and the second weighting factor is within the second image.

8. The image processing device according to claim 2, wherein
the circuitry is configured to control a shooting view angle of the shooting device on a basis of the parameters.

9. The image processing device according to claim 8, wherein
the shooting device includes a PTZ camera, and
the circuitry is configured to control panning, tilting, and zooming of the shooting device.

10. The image processing device according to claim 9, wherein
the circuitry is configured to control the zooming of the shooting device on a basis of distance information associated with at least one person of the plurality of persons in the first image.

11. The image processing device according to claim 2, wherein
the circuitry is configured to determine a cropping range to obtain the second image.

12. The image processing device according to claim 11, wherein
the shooting device includes a wide-angle camera.

13. The image processing device according to claim 1, wherein
the plurality of subjects includes at least one person and at least one object included in the first image.

14. The image processing device according to claim 1, wherein
the first image is in an operational field video, and
the plurality of subjects includes a plurality of operation tools in the operational field video.

15. The image processing device according to claim 1, wherein
the first image is in an observation video of a plurality of biological samples,
the plurality of subjects includes the plurality of biological samples, and
the detected states of the plurality of subjects are behaviors of the plurality of biological samples.

16. The image processing device according to claim 15, wherein
the biological samples are cells, and
the behaviors of the cells include at least one of a beat, division, fusion, bonding, deformation, or movement.

17. The image processing device according to claim 1, wherein
the first image is in an on-vehicle camera video, and
the plurality of subjects includes at least one person and at least one bicycle in the on-vehicle camera video.

18. The image processing device according to claim 17, wherein
the state of the person includes one of walking, running, or stopping, and
the state of the bicycle includes one of traveling straight or meandering.

19. An image processing method, comprising:
detecting states of a plurality of subjects in a first image;
setting, by an image processing device, parameters corresponding to the detected states of the plurality of subjects; and
determining, by the image processing device and on a basis of a combination of the parameters set for the plurality of subjects, an output range to obtain a second image.

20. A non-transitory computer-readable storage medium storing computer-readable instructions thereon, which, when executed by a computer, cause the computer to execute a method comprising:
detecting states of a plurality of subjects in a first image;
setting parameters corresponding to the detected states of the plurality of subjects; and
determining, on a basis of a combination of the parameters set for the plurality of subjects, an output range to obtain a second image.
